(19) United States
(12) Patent Application Publication
(10) Pub. No.: US 2023/0047458 A1
(43) Pub. Date: Feb. 16, 2023

(54) REACTING TO CELL TIMING SOURCE OUTAGE NOTIFICATIONS

(71) Applicant: QUALCOMM Incorporated, San Diego, CA (US)

(72) Inventors: Sony AKKARAKARAN, Poway, CA (US); Jingchao BAO, San Diego, CA (US); Tao LUO, San Diego, CA (US)

(21) Appl. No.: 17/402,440

(22) Filed: Aug. 13, 2021

(51) Int. Cl. H04W 24/04; H04W 56/00; H04B 7/185

(52) U.S. Cl. CPC H04W 24/04; H04W 56/0015; H04B 7/18513; H04W 16/14

(57) ABSTRACT

Techniques are provided for reacting to a notification of a timing source outage in a network node. An example method for reacting to an indication of a timing source outage includes receiving the indication of the timing source outage associated with a first node, and deactivating at least one transmission from the first node.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A wireless communication system may include a number of cells that may operate synchronously or asynchronously. For synchronous operation, the timing of each cell may closely track the timing of neighbor cells. Synchronous operation may be achieved by having each cell align its timing to a reference time source, which may be a global navigation satellite system (GNSS). For asynchronous operation, the timing of each cell may not track and may even be pseudo-random with respect to the timing of neighbor cells. Some features of a wireless communication, such as carrier aggregation (CA) and certain positioning operations depend on synchronization. Local or global GNSS outages may impact the ability of cells to synchronize. A cell may desire to operate synchronously but may temporarily be unable to align its timing to the reference time source due to the GNSS outage. It may be desirable to effectively handle such temporary loss of synchronization due to a GNSS outage in order to mitigate performance degradation.

### SUMMARY

An example method for reacting to an indication of a timing source outage according to the disclosure includes receiving the indication of the timing source outage associated with a first node, and deactivating at least one transmission from the first node.

Implementations of such a method may include one or more of the following features.

The indication of the timing source outage may be a failure to decode a timing related signal received from a satellite with the first node. The indication of the timing source outage may be one or more timing source outage notification messages. The at least one transmission may be associated with a remote radio head deployment. The at least one transmission may be associated with a component carrier in a carrier aggregation procedure. The at least one transmission may be associated with a dual connectivity deployment. The at least one transmission may be associated with a dynamic spectrum sharing deployment. The at least one transmission may be associated with a handover procedure. The at least one transmission may be associated with a cross link interference procedure. Deactivating the at least one transmission may include deactivating the first node.

An example apparatus according to the disclosure includes a memory, at least one transceiver, at least one processor communicatively coupled to the memory and the at least one transceiver, and configured to receive an indication of a timing source outage associated with a first node, and deactivate at least one transmission from the first node.

Implementations of such an apparatus may include one or more of the following features.

The at least one processor may be further configured to determine a failure to decode a signal received from a satellite. The at least one processor may be further configured to receive one or more timing source outage notification messages. The at least one transmission may be associated with a remote radio head deployment. The at least one transmission may be associated with a component carrier in a carrier aggregation procedure. The at least one transmission may be associated with a dual connectivity deployment. The at least one transmission may be associated with a dynamic spectrum sharing deployment. The at least one transmission may be associated with a handover procedure. The at least one transmission may be associated with a cross link interference procedure. The at least one processor may be configured to deactivate the first node.

Items and/or techniques described herein may provide one or more of the following capabilities, as well as other capabilities not mentioned. Satellite navigation systems may be used to synchronize the timing of nodes in a network, however, satellite signals are susceptible to jamming and other effects which may impact reception of the signals and the timing synchronization of the nodes. A node may experience a timing source outage when satellite signals are not received and/or decoded. A node may detect the loss of a timing source and notify the network. The node may also provide a timing drift value. Network nodes may relay the timing source outage information to other network nodes. The network nodes may react to the timing source outage based on an operational context. A node affected by the timing source outage may be turned off or may have one or more transmissions deactivated or modified. The one or more transmissions may be associated with synchronization and timing procedures, multi-cell procedures, mobility procedures, and/or cross link interference procedures. The timing source outage notification messages enable a network to respond to timing source outages. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIG. 5 is a diagram of an example wireless network with a plurality of nodes.

FIG. 6 is an example timing diagram of synchronous operation by three nodes.

FIG. 7 is a diagram of an example network experiencing a timing source outage on a node.

FIG. 8 is an example message flow for notifying network nodes of a timing source outage.

FIG. 9 is an example of information elements in timing source outage notification messages

FIGS. 10A-10C are diagrams of example reactions to a timing source outage in a remote radio head deployment.

FIG. 11 is a diagram of an example timing source outage in a carrier aggregation procedure.

FIG. 12 is a diagram of an example handover procedure based on a timing source outage notification.

FIG. 13 is a diagram of an example cross link interference procedure based on a timing source outage notification.

FIG. 14A is a process flow for an example method for reacting to an indication of a timing source outage.

FIG. 14B is a process flow for an example method for reacting to a timing source outage notification in a remote radio head deployment.

FIG. 15 is a process flow for an example method for reacting to a timing source outage notification during carrier aggregation operations.

FIG. 16 is a process flow for an example method for updating a mobility set based on a timing source outage notification.

FIG. 17 is a process flow for an example method for reacting to a timing source outage notification in a dynamic spectrum sharing deployment.

FIG. 18 is a process flow for an example method for performing cross link interference measurements based on a timing source outage notification.

### DETAILED DESCRIPTION

Techniques are discussed herein for reacting to a notification of a timing source outage in a network node. In general, different communication networks and various features within the communication networks may require synchronization among the network nodes. For example, LTE may utilize synchronous and asynchronous nodes. 5G-NR networks may utilize system frame number (SFN) synchronization in Time Division Duplex (TDD) deployments. Some terrestrial navigation techniques such as Time of Arrival (ToA) and Time Difference of Arrival (TDoA) require that a positioning computation node (e.g., network entity) be aware of synchronization offsets between the nodes transmitting positioning reference signals. Thus, each node must be capable of receiving signals from a timing source to maintain the timing synchronization. Some nodes may utilize the timing signals associated with Global Navigation Satellite Systems (GNSS) to maintain a synchronized time.

GNSS systems are subject to outages for many reasons. For example, local outages may occur due to the presence of a local jammer or a failure/degradation in the receive chain of a GNSS receiver. Global outages, such as with large scale jamming, solar activity, or satellite malfunctions may also cause a station to lose GNSS timing information.

The techniques provided herein include procedures for network nodes to implement in reaction to receiving a notification of a timing source outage impacting one or more network nodes. Timing source outage notifications may be carried as part of a protocol between two or more nodes, and/or relayed via multiple nodes. The timing source outage notifications may include details about the timing outage event, and the receiving nodes may be configure to react based on the details.

In general, a timing source outage on a base station may impact the user equipment within a coverage area. The timing source outage may also impact neighboring nodes, and operations which rely on synchronization of signals transmitted by and/or between different nodes. In an example, a base station (or other node) experiencing a timing source outage may be deactivated or configured to operate at a reduce capability. One or more transmissions of an affected node may be deactivated or reconfigured based at least in part on the timing source outage. The timing source outage notification messages enable other nodes to react to the timing source outage. The reactions may be based on the operational context of the nodes receiving the notification. For example, multiple transmission/reception point (TRP) deployments, such as remote radio head (RRH) deployments, may be configured to implement dynamic switching between TRPs based on a notification of a timing source outage. TRPs configured for full-duplex operations may be de-configured to half-duplex operations based on a timing source outage. Nodes performing carrier aggregation (CA) operations with multiple TRPs may deactivate or reconfigure one or more of the TRPs in response to a timing source outage notification. In an example, the set of component carriers (CCs) in a CA operation may be limited to a single timing advance group (TAG) based on the timing source outage. Other procedures associated with multiple cell operations may be dynamically modified based on a timing source outage notification associated with one or more proximate nodes. For example, mobility sets, such as L1/L2 configured sets, may be modified to remove the impacted nodes, synchronous dual connectivity (DC) operations may be reconfigure to asynchronous, handover procedures and configurations may be modified, and dynamic spectrum sharing (DSS) operations may be suspended or reconfigured. Cross Link Interference (CLI) measurement procedures may also be reconfigured based on a timing source outage notification. Such preconfigured reactions to a timing source outage notification may improve the robustness of a network experiencing a timing source outage. These techniques and configurations are examples, and other techniques and configurations may be used.

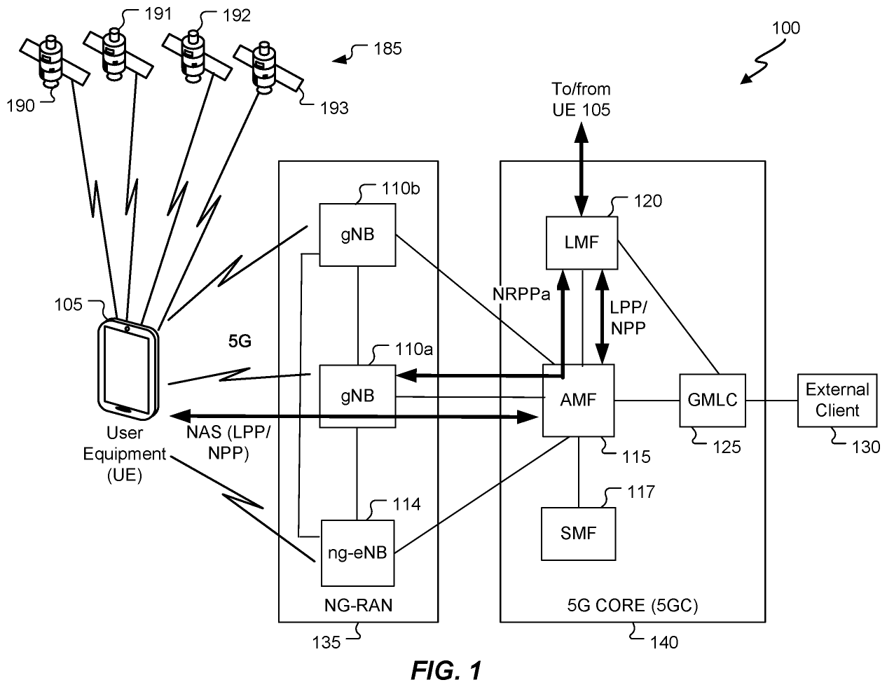

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS).

Additional components of the communication system 100 are described below. The communication system 100 may include additional or alternative components. In an embodiment, the SVs 190, 191, 192, 193 may provide synchronized timing information to the nodes in the communication network 100. For example, the time references in a GNSS system may include GPS time (GPST), GLONASS time (GLONASST), Galileo System Time (GST), BeiDou Time (BDT), or other synchronized timing signals. In an embodiment, the nodes in the communication network 100 may utilize the GNSS timing information as a timing source to maintain synchronization between the nodes. Local or global outages in the GNSS signal may cause timing source outages for some nodes in the network and impact synchronous sensitive procedures (e.g., inter-cell interference coordination, handover, mobility, time-of-flight based positioning, etc.).

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications. The LMF 120 may support positioning of the UE 105 when the UE 105 accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120).

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time Of Arrival (TOA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

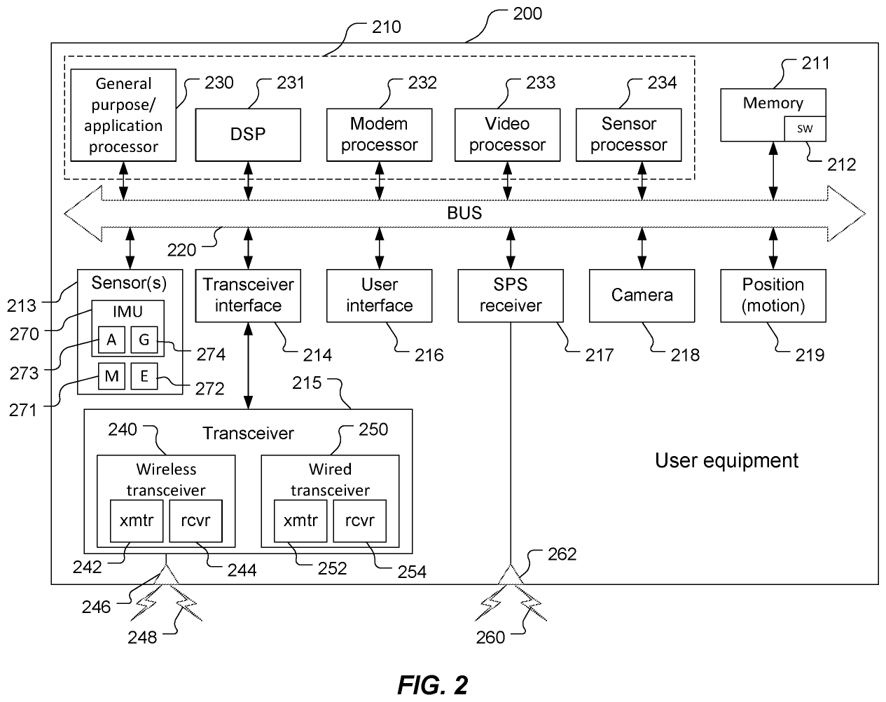

Referring also to FIG. 2, a UE 200 is an example of the UE 105 and comprises a computing platform including a processor 210, memory 211 including software (SW) 212, one or more sensors 213, a transceiver interface 214 for a transceiver 215 (that includes a wireless transceiver 240 and/or a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), V2C (Uu), IEEE 802.11 (including IEEE 802.11p), WiFi, WiFi Direct (WiFi-D), Bluetooth®, Zigbee etc. NR systems may be configured to operate on different frequency layers such as FR1 (e.g., 410-7125 MHz) and FR2 (e.g., 24.25-52.6 GHz), and may extend into new bands such as sub-6 GHz and/or 100 GHz and higher (e.g., FR2x, FR3, FR4). The wired transceiver 250 may include a transmitter 252 and a receiver 254 configured for wired communication, e.g., with the network 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

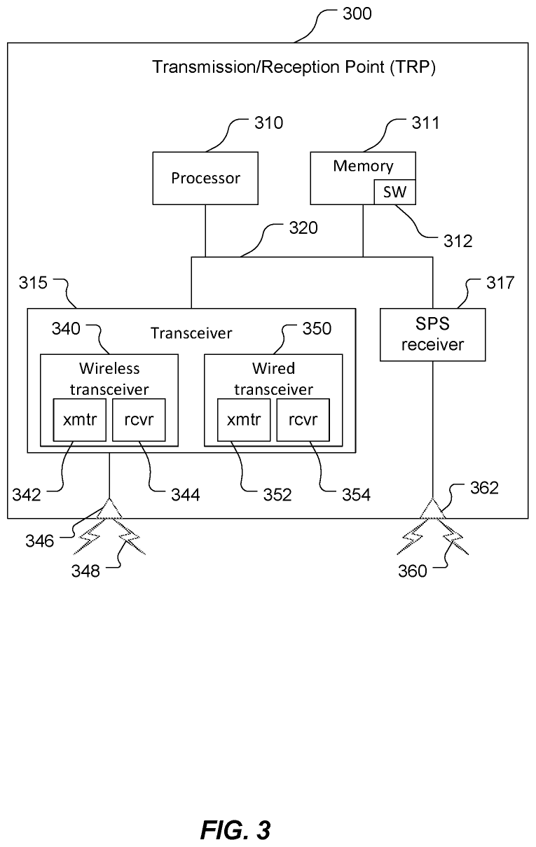

Referring also to FIG. 3, an example of a TRP 300 of the BSs 110a, 110b, 114 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink, downlink, and/or sidelink channels) and/or receiving (e.g., on one or more downlink, uplink and/or sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120 or other network server, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

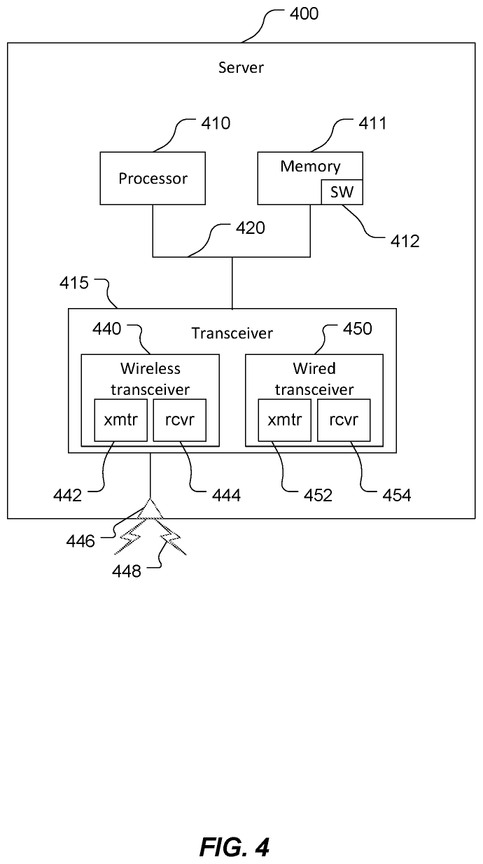

Referring also to FIG. 4, an example server, such as the LMF 120, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the network 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

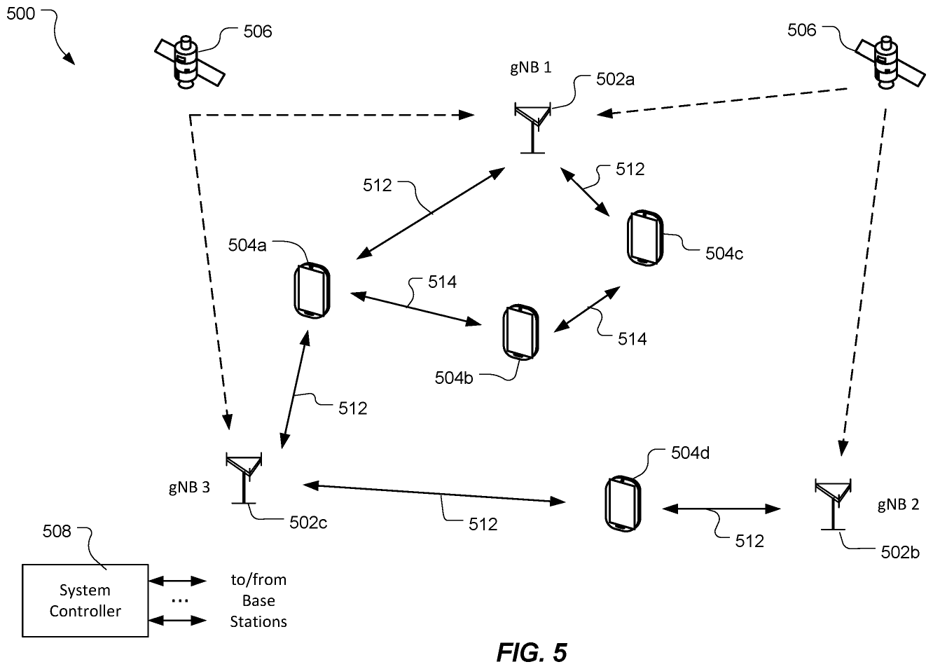

Referring to FIG. 5, an example wireless network 500 with a plurality of nodes is shown. The plurality of nodes may include base stations, such as a first base station 502a, a second base station 502b, and a third base station 502c. Each of the base stations 502a-c may include some or all of the components of the TRP 300, and the TRP 300 may be an example of a base station. In an example, the base stations 502a-c may be included in the NG-RAN 135 such as the gNBs 110a-b and the ng-eNB 114. Each of the base stations 502a-c may provide communication coverage for a particular geographic area. To improve system capacity, the overall coverage area of a base station may be partitioned into multiple (e.g., three) smaller areas. Each smaller area may be served by a respective base station subsystem. The network 500 also includes a plurality of mobile nodes such as a first UE 504a, a second UE 504b, a third UE 504c, and a fourth UE 504d. Each of the UEs 504a-d may include some or all of the components of the UE 200, and the UE 200 may be an example of a UE in the network 500. Other nodes, such as roadside units (RSUs) and Access Points (APs) may also be included in the network 500. The UEs 504a-d may be configured to communicate with the base stations 502a-c via the forward and reverse links 512. The forward link (or downlink) refers to the communication link from a base station to a UE, and the reverse link (or uplink) refers to the communication link from a UE to a base station. The UEs 504a-d may also be configured to communicate with one another via a D2D sidelink protocol 514. For example, in a 5G network, the sidelink protocols 514 may include one or more channels such as a Physical Sidelink Shared Channel (PSSCH), a Physical Sidelink Control Channel (PSCCH), a Physical Sidelink Broadcast Channel (PSBCH), a Sidelink Shared Channel (SL-SCH), and/or other sidelink broadcast channels and synchronization signals.

A system controller 508 may couple to a set of base stations 502a-c and provide coordination and control for the base stations. The system controller 508 may be a single network entity or a collection of network entities. For example, the system controller may include one or more nodes in the 5GC 140 such as the AMF 115 and the LMF 120. The system controller 508 may be an Integrated Access and Backhaul (IAB) node, such as a Central Unit (CU) or Donor Unit (DU).

The nodes in the network 500, including the base stations 502a-d, the UEs 504a-c and the system controller 508, may be configured to receive signals from one or more satellites 506, which may be part of the United States Global Positioning System (GPS), the European Galileo system, the Russian GLONASS system, or some other GNSS. The network nodes may obtain accurate timing information from the satellites and may adjust their timing based on this accurate timing information. All cells in the base station typically have the timing of the base station. The network 500 may support synchronous operation, or asynchronous operation, or either synchronous or asynchronous operation. Synchronous operation may also be referred to as a globally synchronous (GS) mode, and asynchronous operation may also be referred to as a globally asynchronous (GA) mode. The GS mode may assume accurate synchronization of the nodes with respect to a reference time source, e.g., GPS or some other GNSS.

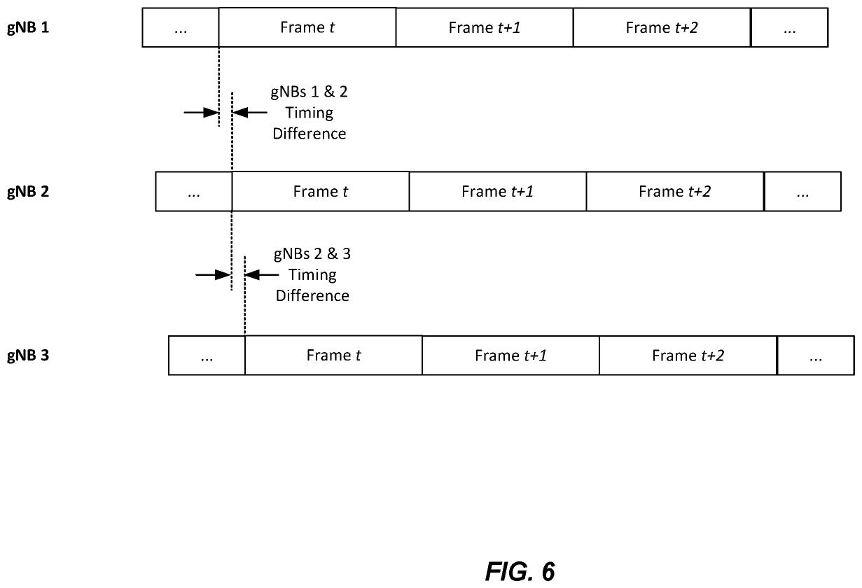

Referring to FIG. 6, a synchronous operation by three nodes is shown. The three nodes include a first base station gNB1, a second base station gNB2, and a third base station gNB3. The transmission timeline may be partitioned into units of radio frames. Each radio frame may span a particular time duration, e.g., 10 milliseconds (ms), and may be assigned a frame number. The frame number may be reset to 0 at a specific time, incremented by one for each radio frame thereafter, and wrap around to zero after reaching a maximum value. For synchronous operation, the timing of each node may closely match the timing of neighbor nodes, and the timing difference between adjacent nodes may be required to meet certain requirements. For example, the timing of a cell may be typically less than 3 microseconds (μsecs) and no greater than 10 μsecs from the timing of the neighbor cells.

Synchronous operation may have certain advantages over asynchronous operation. For example, synchronous operation may improve system capacity due to synchronized interference across nodes, synchronized control channels across nodes, faster handoff due to node switching based on re-pointing instead of random access, etc. Synchronous operation may also reduce complexity of node searches since the timing of undetected nodes may be inferred from the timing of detected nodes. A UE may thus perform node searches over a smaller window around the known timing of a detected node instead of over all possible timing hypotheses.

However, synchronous operation may be associated with additional costs in order to maintain accurate time synchronization. Stringent synchronization accuracy requirements (e.g., better than 3 μsecs typically and no worse than 10 μsecs most of the time) may be achieved with a GNSS receiver as well as a very accurate oscillator at a base station. The GNSS receiver may be used to obtain accurate timing information from satellites, which may be used to update the timing of the nodes (e.g., cells) in the base station. The very accurate oscillator may be used to maintain precise timing for the base station in case of temporary loss of satellite signals due to GNSS outage. For example, the base station may be required to maintain synchronization accuracy (e.g., of 10 μsecs or better) without any satellite signals for a specified holdover duration (e.g., of eight hours). These stringent holdover requirements may be met with the very accurate oscillator. This oscillator may have a very small frequency error and can then provide accurate timing within the required synchronization accuracy for the entire holdover duration.

In an embodiment, a network may be configured to react to a GNSS outage to reduce the dependency on the GNSS timing information and the accuracy of the oscillators in the nodes. For example, messaging protocols may be used to inform network nodes of a GNSS outage and the network may be configured to react to reduce the impact of GNSS outage. In an example, reference signals and D2D sidelink procedures may be used to reestablish the timing in a node experiencing a GNSS timing source outage.

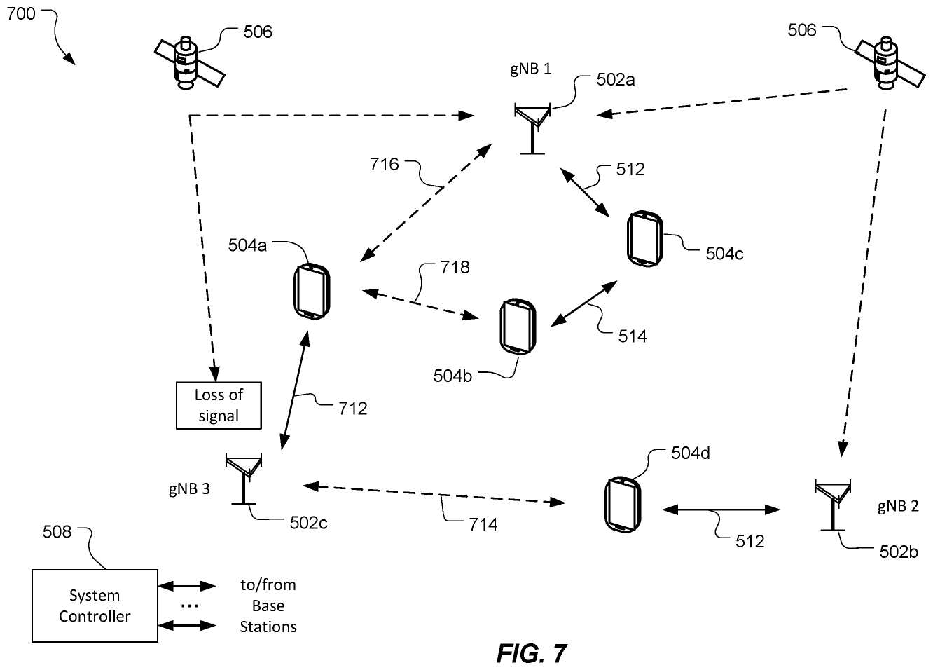

Referring to FIG. 7, an example network 700 experiencing a timing source outage on a node is shown. The network 700 is an example and includes the nodes described in the network 500 depicted in FIG. 5. In this example, the third base station 502c is experiencing a timing source outage due to a lack of signal from the satellite 506. The loss of signal may be based on transmission issues associated with the satellite 506, environmental and/or atmospheric issues (e.g., solar flares), and/or issues associated with the SPS receiver 317 in the third base station 502c. The timing source outage impacting the third base station 502c may be detected by the third base station 502c (i.e., self-reporting), or by other nodes in the network. For example, a UE or base station with access to a timing source may detect an unacceptable timing difference based on reference signals exchanged with the third base station 502c.

The network nodes may be configured to inform other nodes in the network of the timing source outage being experienced by the third base station 502c. In an embodiment, one or more timing source outage messages may include information about the timing source outage and carried as part of a protocol between two nodes. For example, a NRPPa protocol may be used by one of the base stations 502a-c to report the timing source outage to the system controller 508 (e.g., the LMF 120). Radio Resource Control (RRC) protocol may be used to provide timing source outage information between a base station and a UE. JAB protocols such as Xn and F1 may be used to provide the timing source outage information between DUs and CUs. Other protocols may also be used to provide the timing source outage information to external applications (e.g., external clients 130). If multiple protocols are available between the nodes, then the timing source outage information may be carried by one or more of the multiple protocols. For example, in addition to RRC messages, the gNB and a UE may provide timing source outage information via Medium Access Control (MAC) Control Elements (CE), and Downlink Control Information (DCI) signaling. The timing source outage information may be included in System Information Blocks (SIBs), other paging messages, or other dedicated over-the-air (OTA) messages and/or broadcasts. D2D sidelink protocols may also be used to carry the timing source outage information between nodes. In an embodiment, a node may be configured to select one or more protocols to notify other nodes of the timing source outage. Protocol selection rules may be based on the communication context and/or the nature of the timing source outage. For example, DCI or MAC-CE may be permitted for certain types of GNSS quality reports (e.g., an extreme timing outage) or certain UE configurations (e.g., a UE is in a high-priority positioning session which will be directly affected by the outage). Other rules may also be implemented to select a protocol for notifying the network of a timing source outage.

In operation, referring to FIG. 7, the third base station 502c may become aware of the timing source outage based on an inability to decode a timing related GNSS signal. The third signal may provide a first timing source outage message to the system controller 508 via the NRPPa protocol. The system controller 508 may then notify other network nodes (e.g., the first and second base stations 502a-b and/or the UEs 504a-d) of the timing source outage via the NRPPa and/or LPP/NPP protocols. The third base station 502c may also be configured to provide a second timing source outage message to the first UE 504a via on OTA protocol such as RRC, MAC-CE or DCI. The contents of the first and second timing source outage messages may be different. For example, a MAC-CE message may include an indication of the outage and a time stamp. The NRPPa message may include additional information such as an accuracy measure, an outage reason, and expected recovery time. In an embodiment, the first UE 504a may be configured to relay the timing source outage message to other nodes, such as the first base station 502a and/or the second UE 504b. For example, the first UE 504a may provide the timing outage information associated with the third base station 502c to the first base station 502a (e.g., via LPP, Uu, or other uplink protocol), and/or to the second UE 504b (e.g., via D2D, PC5, or other sidelink protocol). The propagation of the timing source outage information may enable the nodes to mitigate the impact of the timing source outage on synchronization critical processes such as mobility, interference coordination, and some positioning methods (e.g., TDoA).

In general, the other nodes in a network may be configured to react in response to an indication that a node is experiencing a timing source outage. A broad solution includes isolating and avoiding and/or reducing usage of the affected cells for regular operations, and/or potentially configuring additional reference signal monitoring to track the impact of the timing source outage to enable some operations. In an example, a UE in the coverage area of the impacted gNB (e.g., connected to the cell, or camped on the cell while idle), such as the first UE 504a, may be able to continue regular data operations via a forward and reverse link 712 even though the third base station 502c may be out of synchronization with the neighboring base stations. Other nodes, such as the fourth UE 504d, may react to the timing source outage by ignoring or minimizing transmissions from the third base station 502c. For example, in reaction to receiving a timing source outage notification from the system controller 508, the fourth UE 504d may ignore SSB or other tracking signals 714 transmitted by the third base station 502c. Other nodes may have other reactions to the notification of a timing source outage. UEs affected by turning off some cells may be served by alternative cells and operations. For example, the first UE 502a may be served by the unaffected first base station 502a via a forward and reverse link 716 (e.g., rather than being served by the impacted third base station 502c). The visibility thresholds for neighboring cells may be relaxed to enable a UE to camp on a new cell. In an embodiment, UE relays may be activated to communicate with UEs in the coverage area of an impacted cell. For example, if the first UE 502a is out of coverage of a base station, the second UE 504b may establish a D2D sidelink 718 with the first UE 504a to establish a relay through the third UE 504c to the first base station 502a.

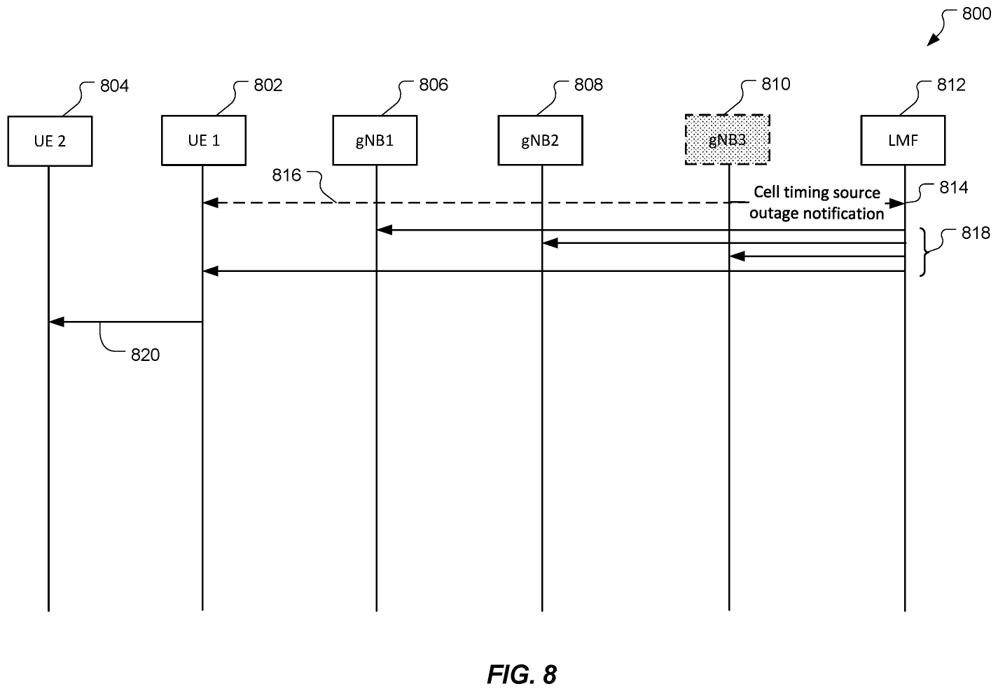

Referring to FIG. 8, an example message flow 800 for notifying network nodes of a timing source outage is shown. The message flow 800 may be based on the communication system 100 and includes a first UE 802, a second UE 804, a first base station 806, a second base station 808, and a third base station 810. The UEs 802, 804 and base stations 806, 808, 810 are configured to communicate with a network server such as an LMF 812. The UEs 802, 804 are examples of a UE 200, and the base stations 806, 808, 810 are examples of a TRP 300 such as the gNBs 110a-b or ng-eNB 114, the LMF 812 is an example of a network server 400 such as the LMF 120. In general, the message flow enables propagation of information and processes when a network node has incurred a timing source outage, For example, the third base station 810 may detect a timing outage based on the loss of GNSS signals. Based on the detection of the timing source outage, the third base station 810 may provide one or more timing source outage notification messages 814 to the LMF 812. In an example, the timing source outage notification messages 814 may utilize NRPPa protocols, or other network messaging protocols, and is configured to provide an indication of the timing source outage to the LMF 812. In addition to, or as an alternative to the timing source outage notification message 814, the third base station 810 may be configured to provide a timing source outage message 816 to one or more in-coverage UEs such as the first UE 802. The timing source outage message 816 may utilize OTA signaling such as RRC, MAC-CE and/or DCI.

The LMF 812 may relay one or more information elements associated with the timing source outage information included in the timing source outage notification message 814 to other network nodes. For example, the LMF 812 may send one or more timing source outage information messages 818 to the base stations 806, 808 and in-coverage UEs (e.g., the first UE 802). In an embodiment, the first UE 802 may utilize a D2D sidelink to relay timing source outage information to out-of-coverage nodes, such as the second UE 804. For example, the first UE 802 may provide one or more sidelink timing outage notification messages 820 to the second UE 804.

The one or more sidelink timing outage notification messages 820 may be containerized or non-containerized based on the timing outage information included in the timing source outage message 816 and/or the timing source outage information messages 818.

In operation, the network nodes may be configured to react based on receipt of the timing outage information. The reactions may vary based on the state of the node and the context associated with the timing outage. For example, in a mobility or handoff context, nodes experiencing a timing outage may be bypassed or deprioritized. In a positioning context, reference signals transmitted from an affected node may be ignored. The LMF 120 may mute one or more signals on an affected node to reduce the potential of time domain interference. Other reactions are also possible to mitigate the impact of the timing source outage. For example, industry standards may be implemented to mandate a reaction in response to receiving an indication of a timing source outage. Reactions may be permanent such that a reconfiguration may be required after the detection of the timing outage, or the reactions may be temporary and include a time limit associated with an indication of the timing source outage.

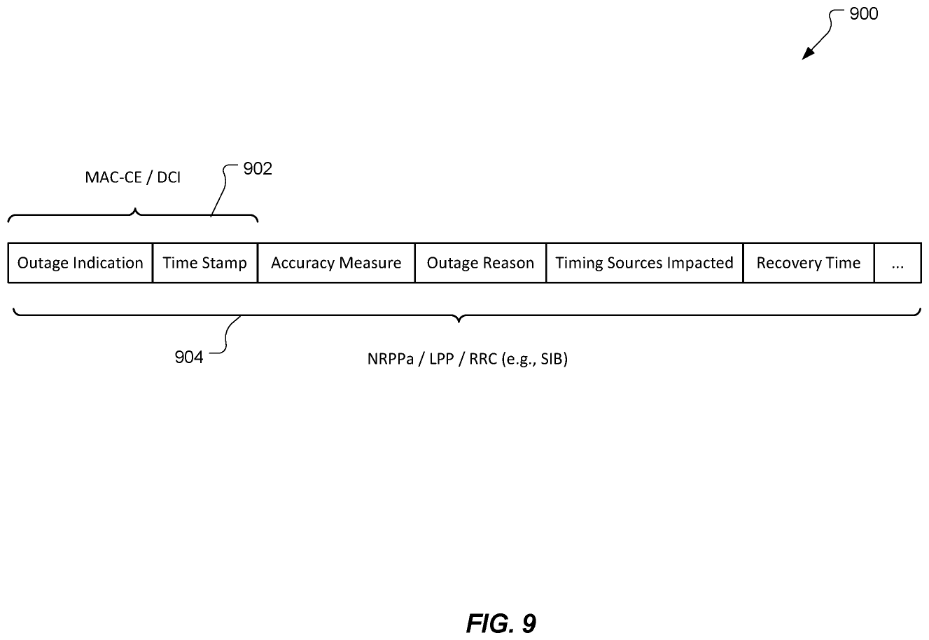

Referring to FIG. 9, example information elements in a timing source outage notification message 900 are shown. In general, the timing source outage notification message 900 contains details about the timing outage event. For example, an outage indication information element (IE) may provide an indication that a station is experiencing a timing outage. The outage indication may include station identification information or other parameters to identify a node in the network. A time stamp IE may indicate when the timing source outage when event occurred and/or was detected. An accuracy measure IE may indicate a synchronization and/or timing accuracy measure (e.g., indicating how much the timing is degraded). One or more outage reason IEs may indicate an estimated reason for the timing source outage. Timing sources impacted and recovery time IEs may be used to indicate a scale of a timing source outage. For example, which GNSS is/are impacted, how many satellites are impacted, the expected recovery time, etc. Other IEs may also be used by a network server (e.g., the LMF) to indicate the scale of a timing source outage. For example, whether the timing source failure is limited to a gNB, or to the gNB and N of its neighbors (e.g., based on messages received from those neighbors), or to the gNB and M of its neighbors based on the reported a type of timing source outage, etc. The IEs in the timing source outage notification message 900 are examples and not limitations as other IEs may also be used to provide details about the timing source outage.

In an embodiment, one or more rules may be implemented based on the context of the nodes sending and receiving timing source outage notification messages 900. For example, an abbreviated timing source outage notification message 902 may be used for certain high priority protocols such as MAC-CE and DCI where data payload constraints may limit the amount of data that may be included in a timing source outage notification message. The abbreviated timing source outage notification message 902 may include the outage indication IE and a time stamp to enable a node to react to the timing source outage. For example, a UE may be configured to react by ignoring positioning reference signals transmitted from a station based on the outage indication. Other reactions may include modifying mobility and handoff procedures to reduce the impact of the timing source outage. An expanded timing source outage notification message 904 may include additional IEs as compared to the abbreviated timing source outage notification message 902. For example, other protocols such as NRPPa, LPP and RRC may be capable of providing an increased number of IEs and the associated details of the timing source outage. The receive nodes may be configured to react based on the additional IEs.

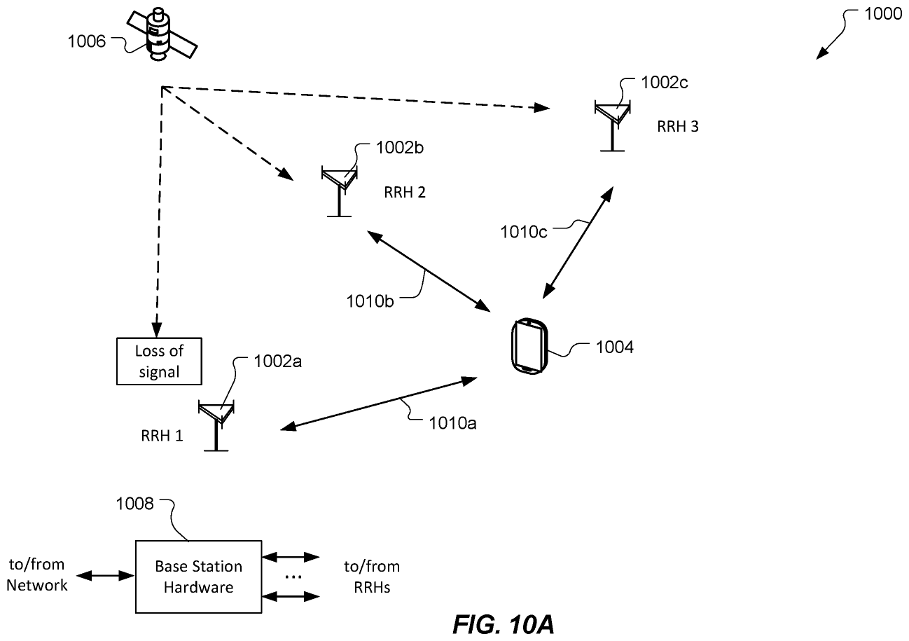

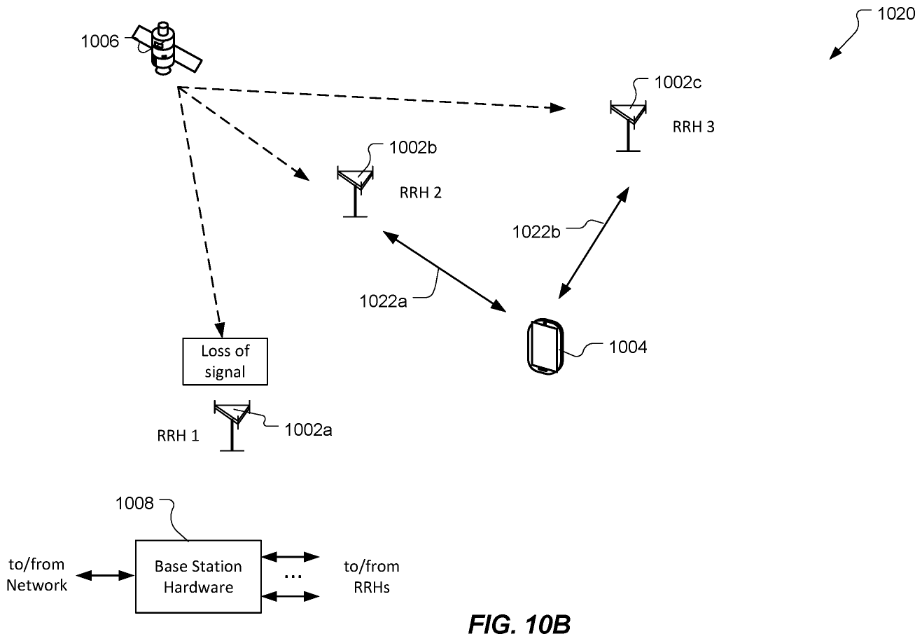

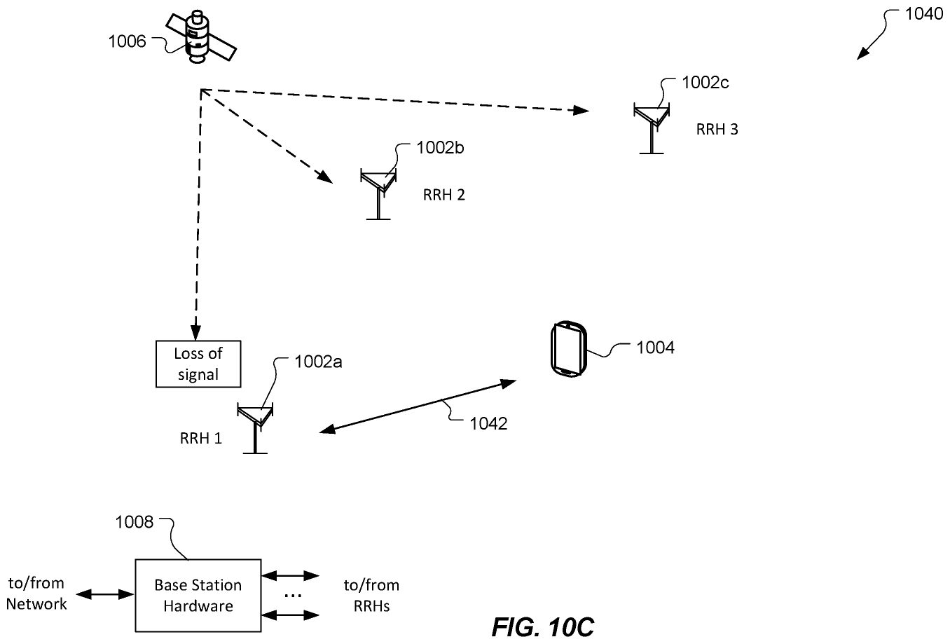

Referring to FIGS. 10A-10C, diagrams of example reactions to a timing source outage in a remote radio head deployment are shown. In general, a remote radio head (RRH) is a remote radio transceiver that connects to a radio base station unit via electrical or wireless interface. An RRH may include some or all of the components of the TRP 300, and the TRP 300 may be an example of a RRH. In an embodiment, the RRH may be installed on a tower-top, or on another tower that is physically some distance away from the base station hardware which is often mounted in an indoor rack-mounted location. RRH deployments may be used to extend the coverage of a BTS/NodeB/eNodeB/gNodeB in rural areas or tunnels. In an example, an RRH may be connected to the BTS/NodeB/eNodeB/gNodeB via a fiber optic cable using Common Public Radio Interface protocols. The RRH may contain RF circuitry plus analog-to-digital/digital-to-analog converters and up/down converters. RRHs may also have operation and management processing capabilities and a standardized optical interface to connect to the rest of the base station.

In a first diagram 1000, a RRH deployment includes a first RRH 1002a, a second RRH 1002b, and a third RRH 1002c. The RRHs 1002a-c may be communicatively coupled to a base station hardware module 1008, which may be communicatively coupled to the communications network 100 (e.g., the LMF 120). Each of the RRHs 1002b may be configured to utilize a timing source such as GNSS, including a satellite 1006. A UE 1004 may be configure to communicate with one or more of the RRHs 1002a-c via one or more channels 1010a-c. For example, the UE 1004 may receive a first channel 1010a from the first RRH 1002a, a second channel 1010b from the second RRH 1002b, and a third channel 1010c from the third RRH 1002c. In operation, a timing source outage may impact one, as subset, or all of the TRPs in a RRH deployment. For example, as depicted in the diagram 1000, the first RRH 1002a is experiencing a timing source outage.

Referring to FIG. 10B, a second diagram 1020 depicts an example response to the timing source outage. Broadly, the first RRH 1002a may be turned off until the timing outage is repaired. The second and third RRHs 1002b-c may be utilized for all communications with the UE 1004 including SSB, synchronization, tracking, and other communication transmissions. A first communication link 1022a between the UE 1004 and the second RRH 1002b, and a second communication link 1022b between the UE 1004 and the third RRH 1002c may utilize one or more channels to exchange data packets. For example, the base station hardware module 1008 may reconfigure the indications of which SSBs are transmitted via common/broadcast (e.g., SIB1), and/or dedicated to the UE 1004 to exclude SSBs transmitted from the first RRH 1002a. In another example, the base station hardware module 1008 may be configured to turn on additional SSBs and/or Tracking Reference Signals (TRS) from impacted TRP(s) (e.g., the first RRH 1002a) to enable the UE 1004 to track time drift(s) associated with the impacted TRP(s). In an example, the base station hardware module 1008 may be configured to provide the UE 1004 an expected time drift (e.g., based on the a free-running inaccurate clock in the first RRH 1002a) to assist the UE 1004 in tracking transmissions from the first RRH 1002a. In an embodiment, the base station hardware module 1008 may be configured to limit receive and transmit channels to be quasi co-located (QCLed) with respect to timing properties (e.g., the average delay, the delay spread (e.g., QCL-A or QCL-C)) with SSBs and/or other signals transmitted for the RRHs 1002b-c, whose timing is in sync with each other.

Referring to FIG. 10C, a third diagram 1040 depicts another example response to the timing source outage. In contrast to turning off the first RRH 1002a off until the timing outage is repaired, the UE 1004 continues to operate using the first RRH 1002a for all communications. For example, the UE 1004 may be configured to track the timing of the first RRH 1002a via a third communication link 1042 and thus is able to continue operations, even if the timing of the first RRH 1002a drifts relative to the other RRHs 1002b-c. In an embodiment, the UE 1004 may be configured to utilize the second and third RRHs 1002b-c with dynamic switching between the RRHs to account for the possible changes in relative timing of the RRHs due to the drift.

While FIGS. 10A-10C depict reactions in a RRH deployment, similar reactions may be used on other multi-TRP deployments such as Coordinated Multipoint (CoMP) which enable a UE to connect to several base stations at once. The reactions in FIGS. 10A-10C may also be extended to master TRP (mTRP) DL via the PDCCH and/or PDSCH, and similar UL procedures. For example, a network may be configured to revert to single TRP operation (e.g., de-configure from multiple to a single Control Resource Set (CORSET) Pool) if the two TRPs lose relative time-synchronization. Full-duplex operations, where a UE may communicate with multiple TRPs and may simultaneously transmit to and receive from a single gNB with multiple TRPs or 2 different gNBs, may revert to half-duplex operations. In either case, if the gNBs or TRPs of single gNB lose relative time-synchronization, the reactions depicted in FIGS. 10A-10C may be applied.

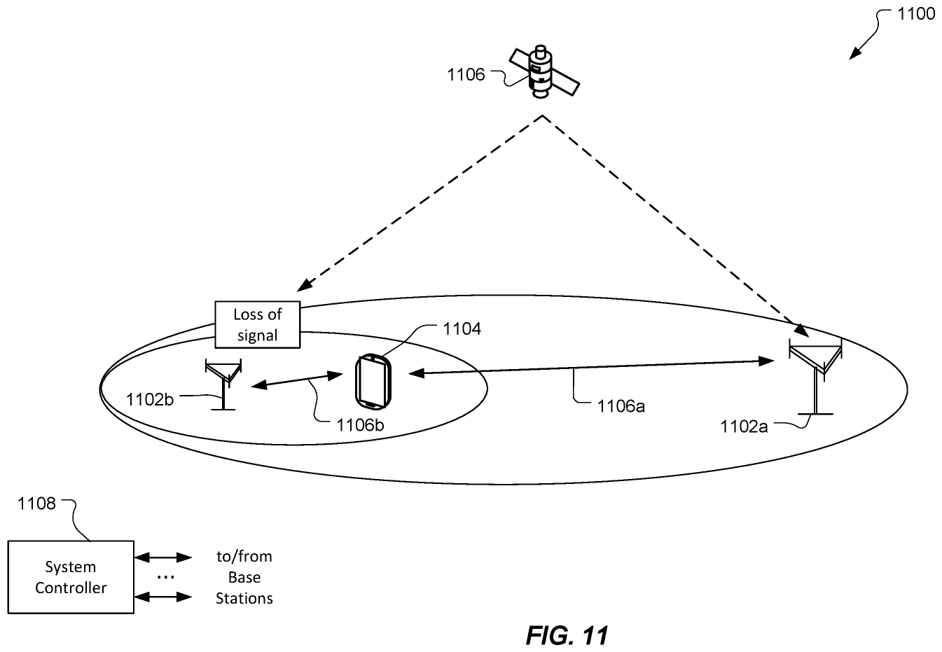

Referring to FIG. 11, a diagram 1100 of an example timing source outage in a carrier aggregation procedure is shown. In general, carrier aggregation (CA) is a concatenation of multiple carriers to increase the bandwidth and data rate of a wireless network. LTE networks may support five bandwidth options 1.4, 3, 5, 10 and 20 MHz, with 5 component carriers (CC) and a maximum bandwidth of 100 MHz. LTE R-13 (i.e. LTE Advanced-PRO), supports 32 CCs and a 640 MHz bandwidth. 5G NR may utilize carrier aggregation with 16 CCs or more. Dual Connectivity (DC) may be configured to utilize carrier aggregation with both LTE and 5G NR carriers. A UE may be configured to simultaneously receive or transmit on one or multiple CCs. Some CA deployments may utilize multiple TRPs with different combinations of CCs. The frame timing and SFN are aligned across cells which can be aggregated. The aligned cells may be classified in one or more timing advance groups (TAG). A TAG may be a subset of the aggregated CCs that share uplink timing and a common timing advance (TA) command. A timing source outage in one or more of the TRPs may impact the operability of a CA deployment.

In an embodiment, the diagram 1100 depicts a first TRP 1102a and a second TRP 1102b in a CA deployment. The TRPs 1102a-b are communicatively coupled to a system controller 1108, and utilize a GNSS timing source, such as a satellite 1106. A UE 1104 may utilize a plurality of CCs on a plurality of communication links such as a first link 1106a between the UE 1104 and the first TRP 1102a, and a second link 1106b between the UE 1104 and the second TRP 1102b. In an example, the second TRP 1102b is experiencing a timing source outage. In general, the timing source outage may impact a subset of CCs being aggregated, or a subset of CCs within a TAG of the aggregated CCs. The affected CCs may or may not be collocated (e.g., in inter-band CA each band may have a separate antenna). The affected CCs may continue to share a common cell-timing (e.g., which may drift more relative to the rest of the network due to the outage), or their timing may drift relative to each other. In an embodiment, in reaction to the timing source outage, the system controller 1108 may be configured to turn off affected CCs, or keep on only a set of CCs (e.g., 1 TAG) that is affected but shares common clock/timing. The term ‘turn off’ may mean de-configure, de-activate, put into dormancy, enable long or short DRX, etc. For example, the system controller 1108 may be configured to turn off the CCs utilizing the second TRP 1102b in response to the timing source outage. In an embodiment, the system controller 1108 may be configured to turn off all CCs in a TAG if a threshold number or fraction of CCs in the TAG have timing outages. The system controller 1108 may be configured to turn on TRS from the affected CC(s) (e.g., 1 CC per affected TAG—so the UEs can track their timing). In stations configured for beam forming, the system controller 1108 may be configured to utilize additional beam formed reference signals because the beams may fail due to mobility/channel variation (e.g., blocking) and timing errors.

In Dual connectivity (DC) deployments, the aggregation of primary & secondary cell-groups may occur at a Packet Data Conversion Protocol (PDCP) layer instead of at a MAC layer. The DC may be synchronous (e.g., the Primary Cell Group (PCG) and the Secondary Cell Group (SCG) may be time-synched) or asynchronous (no time-synch). A UE may be configured to support synchronous DC, or may support both synchronous or asynchronous. The timing-outage solutions described for CA in FIG. 11 may be applied to both PCG and SCG separately. In an example, the PCG and SCG may be interchanged if the timing outage affects PCG more than SCG. For example, the TRPs may be configured to switch from EN-DC to NE-DC, or switch between FR1 and FR2 as PCG in case of FR1/FR2 NN-DC.

The timing outage reactions may vary based on whether the DC deployment is synchronous or asynchronous. For example, as in the CA case, the cell-timing outage could cause the relative timing between the 2 cell-groups to drift, or the relative timing may still remain the same, depending on the gNB implementation and nature of the outage. Asynchronous DC may be more robust to drift across the cell-groups. Signaling may be defined to indicate the relative time difference to some accuracy level. This signaling may be updated to indicate the new drift rate due to the impact of the timing outage. In an embodiment, synchronous DC may be reconfigured to asynchronous due to the outage if the synchronization cannot be maintained. Corresponding changes in power-control modes may be configured to support asynchronous DC. The system controller 1108 (e.g., the LMF 120) may reconfigure a gNB back to synchronous when the timing outage is resolved.

In Dynamic spectrum sharing (DSS) deployments, 2 different radio access technologies (RATs) may be configured to share the same spectrum. A legacy RAT may be unaware of the presence of the newer RAT in the same spectrum. The newer RAT may include support for orthogonalizing its operations (TDM/FDM). For example, DSS between FR1 NR and LTE. Maintaining the orthogonality between the new and legacy RAT may require time-synchronization between the RATs. A cell-timing outage on either or both of these RATs may potentially disrupt this time-synchronization.

In an example, a legacy RAT may not be aware of the presence of a newer RAT, hence the newer RAT may be configure to assume the responsibility of ensuring the time-synchronization (e.g., by monitoring the OTA timing or timing-source of the legacy RAT). The system controller 1108 may reconfigure or suspend DSS operation if a loss of synchronization is detected, due to a timing source outage on one or both of the RATs. Reconfiguration may involve, for example, switching to pure FDM between the two RATs as opposed to a TDM/FDM combination. TDM may be more difficult due to unknown time-alignment. FDM may not ensure orthogonality because there could be cross-channel interference due to OFDM symbol timing misalignment. In an embodiment, a guard band may be established to reduce the impact of the misalignment. In an example, FDM reactions to a timing source outage may include moving NR SSB to a different frequency (e.g., to a new synchronization raster point). TDM reactions may include leaving more guard OFDM symbols to account for the unknown relative timing between the RATs. In an embodiment, a LTE CRS rate-matching pattern may be deactivated (e.g., instead, the whole symbol is left unused) in response to a timing source outage.

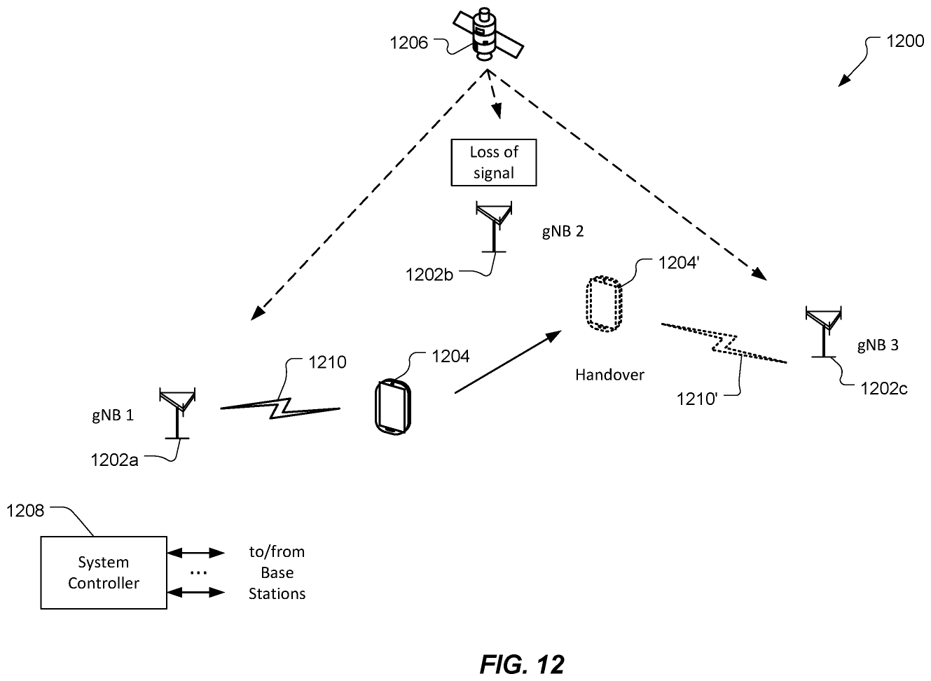

Referring to FIG. 12, a diagram 1200 of an example handover procedure based on a timing source outage notification is shown. In general, the mobility of a UE is network-controlled. The network may reconfigure the UE to connect to different cells to maintain a communication link as the UE moves through a geographical area. When the network determines that a communication link needs to be transferred to a new cell, it sends a handover command to the UE which may include connection information (e.g., RRC configuration) to the new cell for the UE to synchronize to the new cell. The handover process may be negatively impacted when the UE attempts to synchronize with a cell that is experiencing a timing source outage. The diagram 1200 includes a plurality of TRPs including a first gNB 1202a, a second gNB 1202b, and a third gNB 1202c which are communicatively coupled to a system controller 1208. The gNBs 1202a-c may be configured to utilize a satellite 1206 as a timing source. In an example, the second gNB 1202b may experience a timing source outage and provide one or more timing outage notification messages to the system controller 1208, and the system controller 1208 may be configured to modify a handoff procedure to mitigate the timing source outage. For example, a UE 1204 may be utilizing a radio link 1210 with the first gNB 1202a. The UE 1204 may be moving towards the second gNB 1202b and under normal circumstances, the system controller 1208 would send a handover command to enable the UE to synchronize with the second gNB 1202b. In view of the timing source outage, however, the system controller 1208 may send a handover command (e.g., RRC configuration information) to the UE 1204 to synchronize with the third gNB 1202c. The UE 1204 may initiate a handover process at position 1204′ to establish a radio link 1210′ with the third gNB 1202c.

In an embodiment, a network may be configured to utilize L1/L2 mobility. A set of cells may be configured as a L1/L2 configured set for the UE 1204. Among these sets, some sets may be configured as an L1/L2 activated set and may be used for communications, data and/or control. Other cells or sets (e.g., L1/L2 deactivated sets) may be added to the activated set by L1/L2 signaling from a gNB (e.g., the first gNB 1202a), or autonomously added by the UE 1204 (e.g., a L1/L2 candidate set). The UE 1204 may be configured to monitor signal quality from cells in these sets, and cells are added/deleted/moved between these sets based on these measurements, loading, and position/velocity/heading, etc. In reaction to a timing source outage, the UE 1204 and/or the system controller 1208 may be configured to remove the impacted gNBs (e.g., the second gNB 1202b) from, or add them to, one or more of the defined L1/L2 mobility sets. In an example, a set including an impacted gNB may be modified from an L1/L2 activated set to a L1/L2 deactivated set. The UE 1204 may also be configured to increase reference signal monitoring and transmission (e.g., one or more of CSI-RS, TRS, BFD RS, SRS, etc.) from the impacted cells and modify the L1/L2 sets based on reference signals (e.g., move from a L1/L2 deactivated set to a L1/L2 activated set when the timing source is restored).

In an embodiment, a timing source outage notification may be used as a trigger event for conditional handover (CHO) and conditional Primary Secondary Cell Group Cell (PSCell) change (CPC). CHO is a Primary serving Cell (PCell) change initiated by a UE, and CPC is a PSCell change initiated by the UE. The receipt of a timing source outage notification by the UE may be a triggering event to initiate a CHO and/or CPC procedure. In an example, a timing source outage notification may be provided to the system controller 1208 (e.g., the LMF 120), or via a D2D sidelink relay via a station connected to the PCell. In an example, the UE may receive the timing source outage notification from the PCell. If a cell configured as a CHO/CPC target suffers a timing source outage, it may be temporarily or permanently removed from the CHO/CPC configuration.

In a dual active protocol stack handover (DAPS HO), the context and/or configuration of a UE may be maintained at both source and target cells. The UE may be configured to complete a DAPS HO via a RACH message to the target cell. The handover command may be issued by the source cell. In an example, the source cell may be configured to issue the handover command when it detects a timing source outage. After the handover, the DAPS may be configured again with another cell distinct from the source to avoid cells that are experiencing a timing source outage.

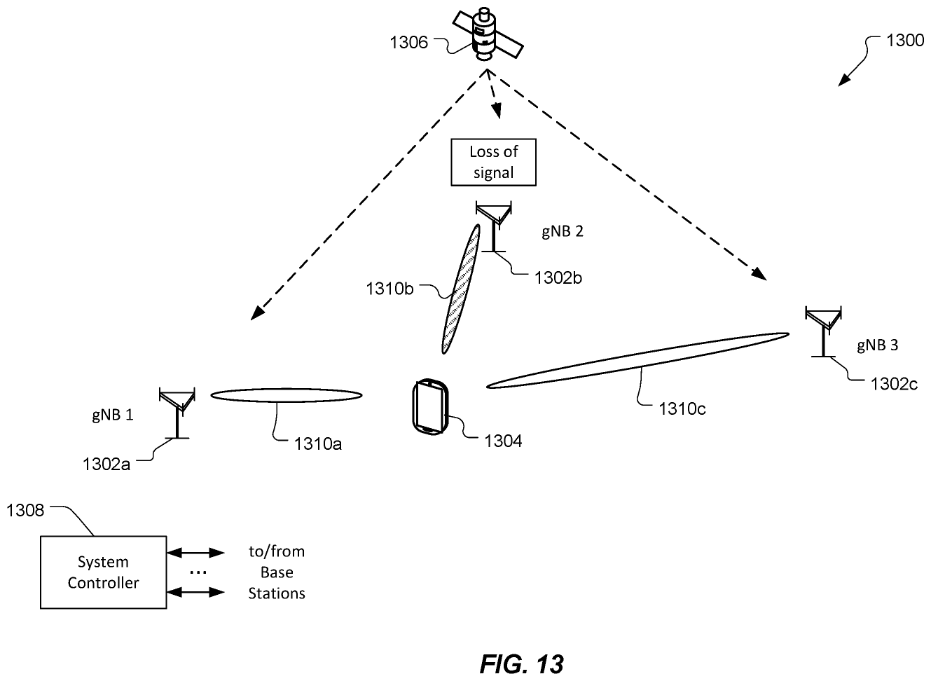

Referring to FIG. 13, a diagram 1300 of an example cross link interference (CLI) procedure based on a timing source outage notification is shown. In general, a UE may be configured to monitor and transmit reference signals (e.g., one or more of CSI-RS, TRS, BFD RS, SRS, etc.) for mobility and CLI procedures. As previously described, the reference signal measurements may be used as trigger events for certain procedures such as UE handover.

Reference signal measurements may be made with or without configured measurement gaps (MGs), depending on the reference signal configuration (e.g., using the same numerology as serving cell may reduce the need for MGs). CLI may also be measured by a UE on neighboring cells SRS for interference management. A timing source outage of either a serving cell or a neighbor cell may reduce the reliability of the measured signals because the relative timing between the serving and the neighbor cell may drift. For example, the diagram 1300 includes a plurality of TRPs including a first gNB 1302a, a second gNB 1302b, and a third gNB 1302c which are communicatively coupled to a system controller 1308. The gNBs 1302a-c may be configured to utilize a satellite 1306 as a timing source. A UE 1304 may be configured to measure reference signals transmitted by the gNBs 1302a-c, such as a first reference signal 1310a transmitted from the first gNB 1302a, a second reference signal 1310b transmitted from the second gNB 1302b, and a third reference signal 1310c transmitted from the third gNB 1302c. In an example, the second gNB 1302b may experience a timing source outage and provide one or more timing outage notification messages to the system controller 1308, and the system controller 1308 may be configured to modify CLI procedures based on the timing source outage. For example, measurements from the second reference signal 1310b (i.e., reference signals from the affected cell) may be de-configured. In an example, measurements without a MG may be changed to utilize a MG to allow the UE 1304 to search for the signal in a time window. The size of the MG may be based on the expected timing drift rate of the impacted station.

In an embodiment, the system controller 1308 may be configured to modify the slot configuration associated with the CLI measurements. 5G NR enables dynamic TDD slot format configuration such that the configuration of the ODFM symbols in slots as DL, UL or flexible. The configuration may be changed based on RRC, MAC-CE, or DCI signaling. Flexible ODFM symbols may be DL or UL based on the slot schedule. The flexible slot configuration may be used with CLI to enable dynamic adaptation to accommodate varying UL/DL traffic splits while also accounting for the resulting interference (e.g., where all 4 combinations (UE, gNB) and (victim, aggressor) are possible). Timing source outages, however, may create timing drifts between the serving and neighboring cell, which may cause the time alignment and interference structure to change and become harder to predict. For example, a UE may synchronize with an out-of-sync gNB, or the UE may synchronize with other gNBs. In either case, the other gNBs may increase CLI-SRS for their serving UEs to transmit, and the UE and the its serving cell(s) may also increase their CLI monitoring. In general, in response to a timing source outage notification, gNBs 1302a-c may reconfigure their slot formats and CLI SRS configs. For example, a gNB may configure more CLI SRS to improve the analysis of the channel interference. In an embodiment, a gNB may configure more flexible OFDM symbols to dynamically adapt to the timing drift.

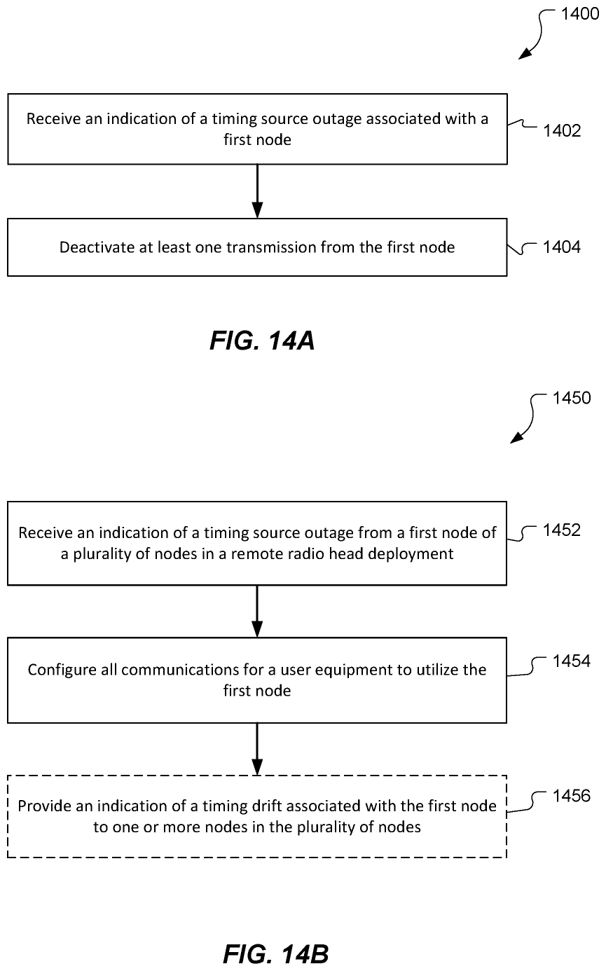

Referring to FIG. 14A, with further reference to FIGS. 1-13, a method 1400 for reacting to an indication of a timing source outage includes the stages shown. The method 1400 is, however, an example and not limiting. The method 1400 may be altered, e.g., by having stages added, removed, rearranged, combined, performed concurrently, and/or having single stages split into multiple stages.

At stage 1402, the method includes receiving an indication of a timing source outage with a first node. A TRP 300, including the processor 310, transceiver 315 and the SPS receiver 317 may be a means for receiving an indication of a timing source outage. In an example, referring to FIG. 8, the first node may be a gNB such as the third base station 810 and may receive an indication of a timing source outage based on a failure to decode a timing related GNSS signal. In an example, a UE in coverage may provide an indication of a timing source outage to a base station based on reference signal measurements. That is, the UE may be configured to detect a synchronization error with the first node as compared to neighboring nodes, and then notify the first node. In an embodiment, a server 400, including the processor 410 and the transceiver 415, may be a means for receiving an indication of a timing source outage. For example, the LMF 812 may receive a timing source outage notification message 814 indicating the first node is experiencing a timing source outage. The timing source outage notification messages 814 may utilize NRPPa protocols, or other network messaging protocols, such as LPP or Uu when the message 814 is sent by a UE.

At stage 1404, the method includes deactivating at least one transmission from the first node. A TRP 300, including the processor 310 and the transceiver 315 may be a means for deactivating the at least one transmission. In an embodiment, the first node may be configured to deactivate or otherwise modify some operational functions based on detecting the timing source outage at stage 1402. In general, deactivating the first node may include de-configuring, turning-off, put into dormancy, enabling long or short DRX, or other modifications to reduce the impact of the timing source outage on client stations. In an embodiment, the first node may receive a timing source outage information message 818 indicating an accuracy measure, and the first node may be configured to deactivate functions based on the accuracy measure.

Deactivating the at least one transmission may include deactivating transmissions associated with synchronization and timing procedures, multi cell procedures, mobility procedures, and/or CLI procedures. For example, the at least one transmission may be associated with a RRH deployment as depicted in FIGS. 10A-10C. The at least one transmission may be associated with a component carrier in a carrier aggregation procedure such as depicted in FIG. 11. The at least one transmission may be associated with a dual connectivity deployment and/or a dynamic spectrum sharing deployment. The at least one transmission may be associated with a handover procedure such as depicted in FIG. 12. The at least one transmission may be associated with a cross link interference procedure such as depicted in FIG. 13. The at least one transmission may be associated with other procedures as described herein as well as other synchronous procedures which may be impacted by a timing source outage.

Referring to FIG. 14B, with further reference to FIGS. 1-13, a method 1450 for reacting to a timing source outage notification in a remote radio head deployment includes the stages shown. The method 1450 is, however, an example and not limiting. The method 1450 may be altered, e.g., by having stages added, removed, rearranged, combined, performed concurrently, and/or having single stages split into multiple stages.

At stage 1452, the method includes receiving an indication of a timing source outage from a first node of a plurality of nodes in a remote radio head deployment. A TRP 300, including the processor 310, transceiver 315 and the SPS receiver 317 may be a means for receiving an indication of a timing source outage. In an example, referring to FIG. 10A, the first node may be the first RRH 1002a and may receive an indication of a timing source outage based on an inability to decode a timing related GNSS signal. In an embodiment, a server 400, including the processor 410 and the transceiver 415, may be a means for receiving an indication of a timing source outage. For example, the base station hardware module 1008 may receive a timing source outage notification message from a network server (e.g., the LMF 120) or the UE 1004 indicating the first RRH 1002a is experiencing a timing source outage.

At stage 1454, the method includes configuring all communications for a user equipment to utilize the first node. The server 400, including the processor 410 and the transceiver 415, may be a means for configuring all communications for the user equipment. In an example, referring to FIG. 10C, the base station hardware module 1008 may be configured enable the UE 1004 to continue to operate using the first RRH 1002a for all communications. For example, the UE 1004 may be configured to track the timing of the first RRH 1002a via a third communication link 1042 and thus is able to continue operations, even if the timing of the first RRH 1002a drifts relative to the other RRHs 1002b-c.

At stage 1456, the method optionally includes providing an indication of a timing drift associated with the first node to one or more nodes in the plurality of nodes. The server 400, including the processor 410 and the transceiver 415, may be a means for providing an indication of the timing drift. In an example, referring to FIG. 10C, the base station hardware module 1008 may be configured to monitor the timing values of the plurality of nodes (e.g., the RRHs 1002a-c) to determine a timing drift value for the time utilized by the first RRH 1002a, and then provide the timing drift value to the UE 1004 via the third communication link 1042. In an embodiment, the UE 1004 may be configured to utilize the second and third RRHs 1002b-c with dynamic switching between the RRHs to account for the possible changes in relative timing of the RRHs due to the potential timing drift caused by the timing source outage.

The method 1450 utilizes RRH as an example, but the method is not so limited. Other deployments with multiple TRPs which are not collocated may utilize the method 1450. For example, a system controller such as the LMF 120, may be configured perform the method 1450.

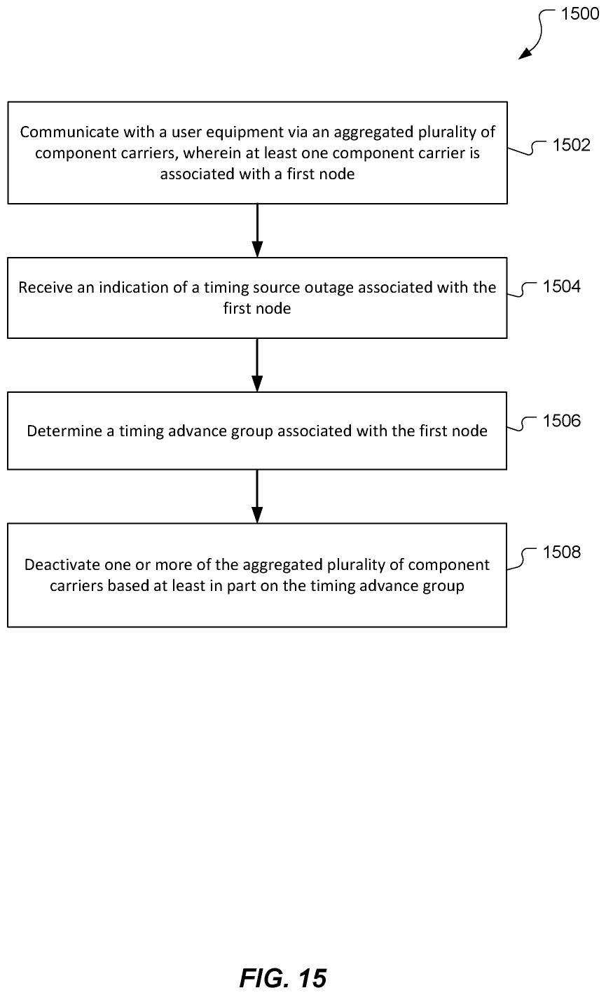

Referring to FIG. 15, with further reference to FIGS. 1-13, a method 1500 for reacting to a timing source outage notification in a carrier aggregation procedure includes the stages shown. The method 1500 is, however, an example and not limiting. The method 1500 may be altered, e.g., by having stages added, removed, rearranged, combined, performed concurrently, and/or having single stages split into multiple stages.

At stage 1502, the method includes communicating with a user equipment via an aggregated plurality of component carriers, wherein at least one component carrier is associated with a first node. A server 400, including the processor 410 and the transceiver 415, may be a means for communicating with the user equipment via an aggregated plurality of component carriers. In an embodiment, referring to FIG. 11, the system controller 1108 is an example of a server 400 communicatively coupled to a plurality of TRPs 1102a-b and configured to communicate with the UE 1104 via carrier aggregation. The UE 1104 may utilize a plurality of CCs on a plurality of communication links such as a first link 1106a between the UE 1104 and the first TRP 1102a, and a second link 1106b between the UE 1104 and the second TRP 1102b.

At stage 1504, the method includes receiving an indication of a timing source outage associated with the first node. The server 400, including the processor 410 and the transceiver 415, may be a means for receiving an indication of the timing source outage. Referring to FIG. 11, the second TRP 1102b may detect a timing source outage based on a failure to decode timing related signals from the satellite 1106 and provide an indication of the timing source outage to the system controller 1108. In an embodiment, the system controller 1108 may receive an indication of the timing source outage from another node such as a UE (e.g., via the first TRP 1102a), or a network server (e.g., the LMF 120).

At stage 1506, the method includes determining a timing advance group associated with the first node. The server 400, including the processor 410, may be a means for determining the TAG. The timing source outage detected at stage 1504 may impact a subset of CCs being aggregated, or a subset of CCs within a TAG of the aggregated CCs. A TAG consists of one or more serving cells with the same uplink TA and same downlink timing reference cell. Each TAG contains at least one serving cell with configured uplink, and the mapping of each serving cell to a TAG is configured by RRC. The system controller 1108 may be configured to assign a TAG ID (e.g., sTAG) and a TAG specific alignment timer for each TRP, and correspondingly determine the TAG ID for a specific TRP.

At stage 1508, the method includes deactivating one or more of the aggregated plurality of component carriers based at least in part on the timing advance group. The server 400, including the processor 410 and the transceiver 415, may be a means for deactivating one or more of the aggregated plurality of component carriers. In an embodiment, the system controller 1108 may be configured to deactivate affected CCs, or keep on only a set of CCs (e.g., 1 TAG) that is affected but shares common clock/timing. The term deactivate may mean de-configure, turn-off, put into dormancy, enable long or short DRX, etc. For example, the system controller 1108 may be configured to turn off the CCs utilizing the second TRP 1102b in response to the timing source outage. In an embodiment, the system controller 1108 may be configured to turn off all CCs in a TAG if a threshold number or fraction of CCs in the TAG have a timing outage. The system controller 1108 may be configured to turn off all CCs in a number of TAGs (which may share a common clock) beyond a threshold (e.g., more than 2 or 3). The system controller 1108 may be configured to turn on TRS from the affected CC(s) (e.g., 1 CC per affected TAG) so the UEs can track their timing.

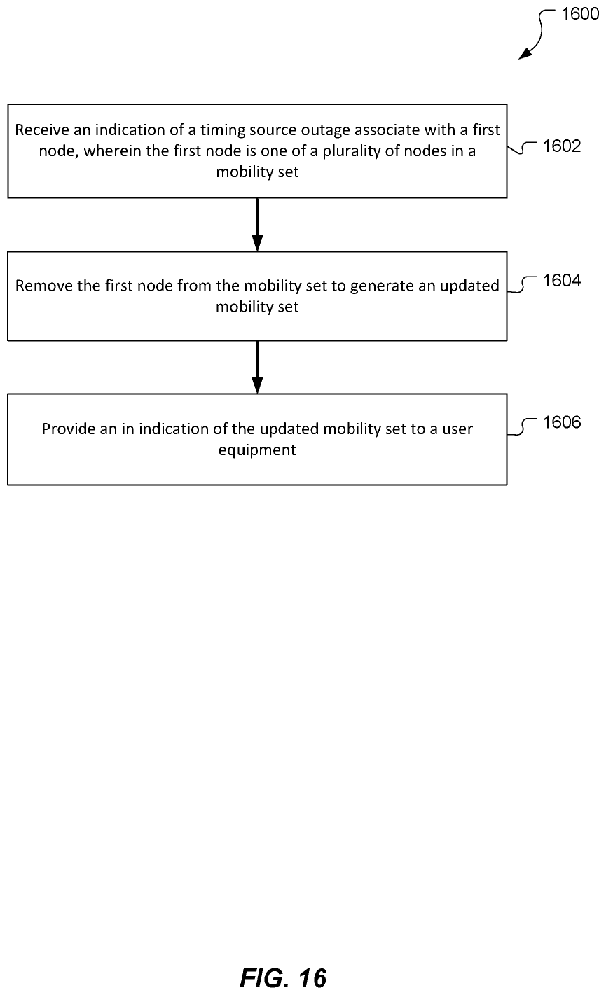

Referring to FIG. 16, with further reference to FIGS. 1-13, a method 1600 for updating a mobility set based on a timing source outage notification includes the stages shown. The method 1600 is, however, an example and not limiting. The method 1600 may be altered, e.g., by having stages added, removed, rearranged, combined, performed concurrently, and/or having single stages split into multiple stages.

At stage 1602, the method includes receiving an indication of a timing source outage associated with a first node, wherein the first node is one of a plurality of nodes in a mobility set. A server 400, including a processor 410 and a transceiver 415, may be a means for receiving an indication of a timing source outage. A system controller such as the LMF 120 may be configured to receive one or more timing source outage notification messages 814 indicating that a node is experiencing a timing source outage. For example, referring to FIG. 12, the system controller 1208 may receive an indication that the second gNB 1202b is experiencing a timing source outage. The network in the diagram 1200 may be configured to utilize L1/L2 mobility. The system controller 1208 may include a data structure (e.g., table, flat file, etc.) describing a L1/L2 configured set for the UE 1204. The second gNB 1202b may be included in the L1/L2 configured set, and may further be configured as a L1/L2 activated set for communications, data and/or control.

At stage 1604, the method includes removing the first node from the mobility set to generate an updated mobility set. The server 400, including the processor 410, may be a means for removing the first node from the mobility set. In reaction to a timing source outage, the system controller 1208 may be configured to remove the first node (e.g., the second gNB 1202b) from, or add them to, one or more of the defined L1/L2 mobility sets. For example, the system controller 1208 may be configured to remove the first node from a data structure which describes the L1/L2 mobility set. In an example, a set including the first node may be modified from an L1/L2 activated set to a L1/L2 deactivated set.

At stage 1606, the method includes providing an indication of the updated mobility set to a user equipment. The server 400, including the processor 410 and the transceiver 415, may be a means for providing an indication of the updated mobility set to the UE. In an example, the system controller 1208 may provide information defining the modified mobility set to the UE 1204 via network signaling such as LPP (i.e., from the LMF 120) or RRC, MAC-CE, and/or DCI (e.g., from the first gNB 1202a). In an example, the modified mobility set information may be included in one or more SIBs transmitted from the first gNB 1202a via the radio link 1210. The indication of the updated mobility set may also configure the UE 1204 to increase reference signal monitoring (e.g., one or more of CSI-RS, TRS, BFD RS, SRS, etc.) from the impacted cells and modify the L1/L2 sets based on reference signals (e.g., move from a L1/L2 deactivated set to a L1/L2 activated set when the timing source is restored).

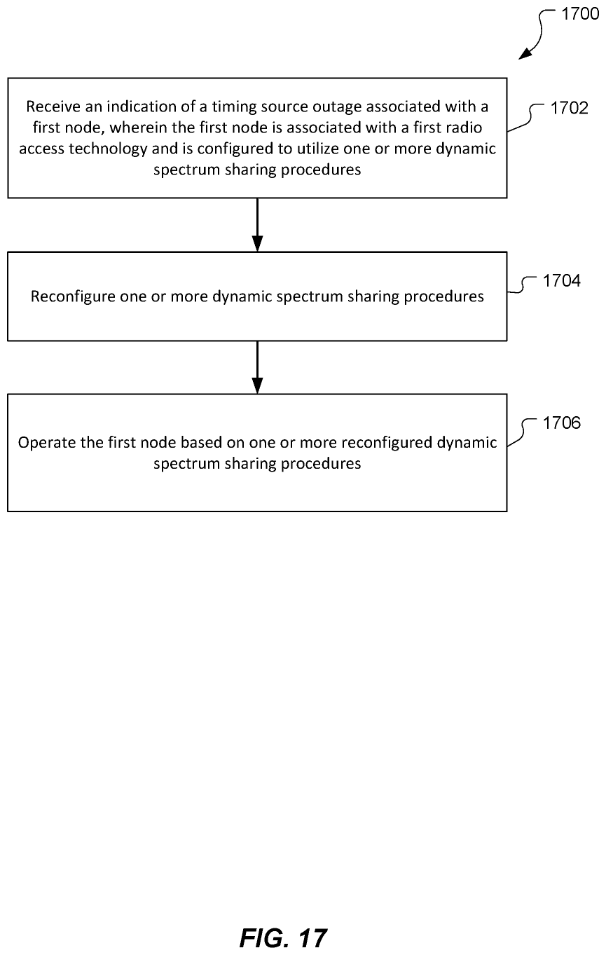

Referring to FIG. 17, with further reference to FIGS. 1-13, a method 1700 for reacting to a timing source outage notification in a dynamic spectrum share deployment includes the stages shown. The method 1700 is, however, an example and not limiting. The method 1700 may be altered, e.g., by having stages added, removed, rearranged, combined, performed concurrently, and/or having single stages split into multiple stages.

At stage 1702, the method includes receiving an indication of a timing source outage associated with a first node, wherein the first node is associated with a first radio access technology and is configured to utilize one or more dynamic spectrum sharing procedures. A server 400, including a processor 410 and a transceiver 415, may be a means for receiving an indication of a timing source outage. A system controller such as the LMF 120 may be configured to receive one or more timing source outage notification messages 814 indicating that a node is experiencing a timing source outage. In an embodiment, a network may include multiple base stations such that each base station may utilize one or more radio access technologies. In an embodiment, the diagram 1100 may be used to describe a DSS deployment. The first TRP 1102a may be configured to utilize a first RAT (e.g., FR1 NR), and the second TRP 1102b may be configured to utilize a second RAT (e.g., LTE). The TRPs 1102a-b may be configured to share the same spectrum. In an example, the second TRP 1102b may experience a timing source outage based on a loss of a signal from the satellite 1106 and provide a timing source outage notification message to the system controller 1108.

At stage 1704, the method includes reconfiguring one or more dynamic spectrum sharing procedures. The server 400, including the processor 410 and the transceiver 415, may be a means for reconfiguring the one or more DSS procedures. The system controller 1108 may reconfigure or suspend DSS operation based on the outage detected at stage 1702. In an embodiment, the reconfiguration may include switching to pure FDM between the two RATs as opposed to a TDM/FDM combination. In an embodiment, a guard band may be established to reduce the impact of the timing synchronization misalignment. In an example, FDM reactions to a timing source outage may include moving NR SSB to a different frequency (e.g., to a new synchronization raster point). TDM reactions may include leaving more guard OFDM symbols to account for the unknown relative timing between the RATs. In an embodiment, a LTE CRS rate-matching pattern may be deactivated in response to a timing source outage.

At stage 1706, the method includes operating the first node based on one or more reconfigured dynamic spectrum sharing procedures. The server 400, including the processor 410 and the transceiver 415, may be a means for operating the first node. In an embodiment, the system controller 1108 may operate the second TRP 1102b (e.g., the first node) based on the reconfiguration selected at stage 1704. For example, the system controller 1108 may suspend DSS operation, switch to pure FDM, establish a guard band, move the NR SSB to a different frequency, leave more guard OFDM symbols, and/or deactivate the LTE CRS rate-matching pattern. The reconfigured DSS procedures may be provided to the second TRP 1102b via network protocols such as NRPPa, or other wired and/or wireless signaling procedures.

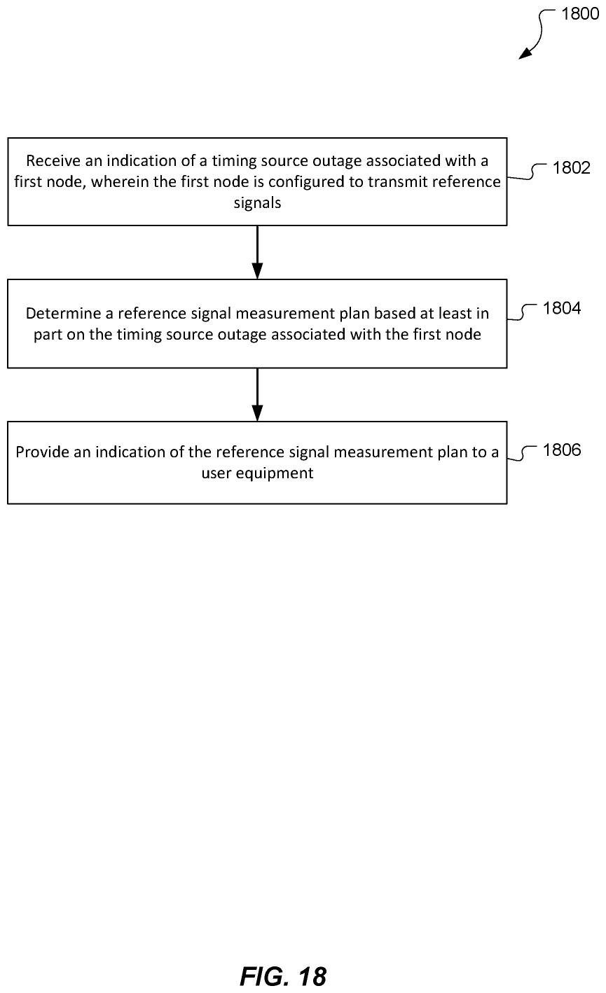

Referring to FIG. 18, with further reference to FIGS. 1-13, a method 1800 for performing cross link interference measurements based on a timing source outage notification includes the stages shown. The method 1800 is, however, an example and not limiting. The method 1800 may be altered, e.g., by having stages added, removed, rearranged, combined, performed concurrently, and/or having single stages split into multiple stages.

At stage 1802, the method includes receiving an indication of a timing source outage associated with a first node, wherein the first node is configured to transmit reference signals. A server 400, including a processor 410 and a transceiver 415, may be a means for receiving an indication of a timing source outage. A system controller such as the LMF 120 may be configured to receive one or more timing source outage notification messages 814 indicating that a node is experiencing a timing source outage. For example, referring to FIG. 13, the system controller 1308 may receive an indication that the second gNB 1302b is experiencing a timing source outage. In an example, the UE 1304 may be configured to monitor reference signals (e.g., one or more of CSI-RS, TRS, BFD RS, SRS, etc.) from the gNBs 1302a-c. In an example, the second gNB 1302b may experience a timing source outage and provide one or more timing outage notification messages to the system controller 1308, and the system controller 1308 may be configured to modify a reference signal measurement plan based on the timing source outage.

At stage 1804, the method includes determining a reference signal measurement plan based at least in part on the timing source outage associated with the first node. The server 400, including the processor 410, may be a means for determining the reference signal measurement plan. In an embodiment the reference signal measurement plan may include de-configuring measurements based on reference signals transmitted from the first node (e.g., the affected cell).

The measurement plan may include changing measurements without a MG to utilize a MG to allow the UE 1304 to search for the signal in a time window. The size of the MG may be based on the expected timing drift rate of the impacted station. The measurement plan may include modifying the slot configuration associated with the CLI measurements via dynamic TDD slot format configurations. For example, a UE may synchronize with an out-of-sync gNB, or the UE may synchronize with other gNBs. In either case, the other gNBs may increase CLI-SRS for their serving UEs to transmit, and the UE and the its serving cell(s) may also increase their CLI monitoring. Other measurement plans may also be created to reduce the impact of the timing source outage and corresponding timing drift in the first node. For example, in an embodiment the reference signal measurement plan may be used with CLI to enable dynamic adaptation to accommodate varying UL/DL traffic splits while also accounting for the resulting interference (e.g., where all 4 combinations (UE, gNB) and (victim, aggressor) are possible). The reference signal measurement plan may enable the gNBs 1302a-c to reconfigure their slot formats and CLI SRS configs. For example, a gNB may configure more CLI SRS to improve the analysis of the channel interference. In an embodiment, a gNB may configure more flexible OFDM symbols to dynamically adapt to the timing drift.

At stage 1806, the method includes providing an indication of the reference signal measurement plan to a user equipment. The server 400, including the processor 410 and the transceiver 415, may be a means for providing the indication of the reference signal measurement plan to the UE. In an embodiment, the system controller 1308 may be configured to provide the reference signal management plan to the UE 1304 via LPP or other signaling via the first gNB 1302a. For example, the gNB 1302a may receive the reference signal measurement plan from the system controller 1308 and provide the reference signal measurement plan via over-the-air messages such as RRC, MAC-CE, or DCI signaling. In an embodiment, the reference signal measurement plan may be included in one or more SIBs transmitted from one of the gNBs 1302a-c.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in the LMF 120 may be performed outside of the LMF 120 such as by the TRP 300.

Components, functional or otherwise, shown in the figures and/or discussed herein as being connected or communicating with each other are communicatively coupled unless otherwise noted. That is, they may be directly or indirectly connected to enable communication between them.

As used herein, unless otherwise stated, a statement that a function or operation is “based on” an item or condition means that the function or operation is based on the stated item or condition and may be based on one or more items and/or conditions in addition to the stated item or condition.

As used herein, the singular forms “a,” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure). Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

1. A method for reacting to an indication of a timing source outage, comprising:

receiving the indication of the timing source outage associated with a first node; and

deactivating at least one transmission from the first node.

2. The method of clause 1 wherein the indication of the timing source outage is a failure to decode a timing related signal received from a satellite with the first node.

3. The method of clause 1 wherein the indication of the timing source outage is one or more timing source outage notification messages.

4. The method of clause 1 wherein the at least one transmission is associated with a remote radio head deployment.

5. The method of clause 1 wherein the at least one transmission is associated with a component carrier in a carrier aggregation procedure.

6. The method of clause 1 wherein the at least one transmission is associated with a dual connectivity deployment.

7. The method of clause 1 wherein the at least one transmission is associated with a dynamic spectrum sharing deployment.

8. The method of clause 1 wherein the at least one transmission is associated with a handover procedure.

9. The method of clause 1 wherein the at least one transmission is associated with a cross link interference procedure.

10. The method of clause 1 wherein deactivating the at least one transmission includes deactivating the first node.

11. An apparatus, comprising:

a memory;

at least one transceiver;

at least one processor communicatively coupled to the memory and the at least one transceiver, and configured to:

receive an indication of a timing source outage associated with a first node; and

deactivate at least one transmission from the first node.

12. The apparatus of clause 11 wherein the at least one processor is further configured to determine a failure to decode a signal received from a satellite.

13. The apparatus of clause 11 wherein the at least one processor is further configured to receive one or more timing source outage notification messages.

14. The apparatus of clause 11 wherein the at least one transmission is associated with a remote radio head deployment.

15. The apparatus of clause 11 wherein the at least one transmission is associated with a component carrier in a carrier aggregation procedure.

16. The apparatus of clause 11 wherein the at least one transmission is associated with a dual connectivity deployment.

17. The apparatus of clause 11 wherein the at least one transmission is associated with a dynamic spectrum sharing deployment.

18. The apparatus of clause 11 wherein the at least one transmission is associated with a handover procedure.

19. The apparatus of clause 11 wherein the at least one transmission is associated with a cross link interference procedure.

20. The apparatus of clause 11 wherein the at least one processor is configured to deactivate the first node.

21. An apparatus for reacting to an indication of a timing source outage, comprising:

means for receiving the indication of the timing source outage associated with a first node; and

means for deactivating at least one transmission from the first node.

22. The apparatus of clause 21 wherein the indication of the timing source outage is a failure to decode a signal received from a satellite with the first node.

23. The apparatus of clause 21 wherein the indication of the timing source outage is one or more timing source outage notification messages.

24. The apparatus of clause 21 wherein the at least one transmission is associated with a remote radio head deployment.

25. The apparatus of clause 21 wherein the at least one transmission is associated with a component carrier in a carrier aggregation procedure.

26. A non-transitory processor-readable storage medium comprising processor-readable instructions configured to cause one or more processors to react to an indication of a timing source outage, comprising:

code for receiving the indication of the timing source outage associated with a first node; and

code for deactivating at least one transmission from the first node.

27. The non-transitory processor-readable storage medium of clause 26 wherein the at least one transmission is associated with a dual connectivity deployment or a dynamic spectrum sharing deployment.

28. The non-transitory processor-readable storage medium of clause 26 wherein the at least one transmission is associated with a handover procedure.

29. The non-transitory processor-readable storage medium of clause 26 wherein the at least one transmission is associated with a cross link interference procedure.

30. The non-transitory processor-readable storage medium of clause 26 further comprising code for deactivating the first node.

31. A method for reacting to a timing source outage notification in a remote radio head deployment, comprising:

receiving an indication of a timing source outage from a first node of a plurality of nodes in the remote radio head deployment; and

configuring all communications for a user equipment to utilize the first node.

32. The method of clause 31 further comprising providing an indication of a timing drift associated with the first node to one or more nodes in the plurality of nodes.

33. An apparatus, comprising:

a memory;

at least one transceiver;

at least one processor communicatively coupled to the memory and the at least one transceiver, and configured to:

receive an indication of a timing source outage from a first node of a plurality of nodes in the remote radio head deployment; and

configure all communications for a user equipment to utilize the first node.

34. The apparatus of clause 33 wherein the at least one processor is further configure to provide an indication of a timing drift associated with the first node to one or more nodes in the plurality of nodes.

35. An apparatus for reacting to a timing source outage notification in a remote radio head deployment, comprising:

means for receiving an indication of a timing source outage from a first node of a plurality of nodes in the remote radio head deployment; and

means for configuring all communications for a user equipment to utilize the first node.

36. A method for reacting to a timing source outage notification in a carrier aggregation deployment, comprising:

communicating with a user equipment via an aggregated plurality of component carriers, wherein at least one component carrier is associated with a first node;

receiving an indication of a timing source outage associated with the first node;

determining a timing advance group associated with the first node; and

deactivating one or more of the aggregated plurality of component carriers based at least in part on the timing advance group.

37. An apparatus, comprising:

a memory;

at least one transceiver;

at least one processor communicatively coupled to the memory and the at least one transceiver, and configured to:

communicate with a user equipment via an aggregated plurality of component carriers, wherein at least one component carrier is associated with a first node;

receive an indication of a timing source outage associated with the first node;

determine a timing advance group associated with the first node; and

deactivate one or more of the aggregated plurality of component carriers based at least in part on the timing advance group.

38. An apparatus for reacting to a timing source outage notification in a carrier aggregation deployment, comprising:

means for communicating with a user equipment via an aggregated plurality of component carriers, wherein at least one component carrier is associated with a first node;

means for receiving an indication of a timing source outage associated with the first node;

means for determining a timing advance group associated with the first node; and

means for deactivating one or more of the aggregated plurality of component carriers based at least in part on the timing advance group.

39. A method for updating a mobility set based on a timing source outage notification, comprising:

receiving an indication of a timing source outage associate with a first node, wherein the first node is one of a plurality of nodes in the mobility set;

removing the first node from the mobility set to generate an updated mobility set; and

providing an in indication of the updated mobility set to a user equipment.

40. An apparatus, comprising:

a memory;

at least one transceiver;

at least one processor communicatively coupled to the memory and the at least one transceiver, and configured to:

receive an indication of a timing source outage associate with a first node, wherein the first node is one of a plurality of nodes in a mobility set;

remove the first node from the mobility set to generate an updated mobility set; and

provide an in indication of the updated mobility set to a user equipment.

41. An apparatus for updating a mobility set based on a timing source outage notification, comprising:

means for receiving an indication of a timing source outage associate with a first node, wherein the first node is one of a plurality of nodes in the mobility set;

means for removing the first node from the mobility set to generate an updated mobility set; and

means for providing an in indication of the updated mobility set to a user equipment.

42. A method for reacting to a timing source outage notification in a dynamic spectrum sharing deployment, comprising:

receiving an indication of a timing source outage associated with a first node, wherein the first node is associated with a first radio access technology and is configured to utilize one or more dynamic spectrum sharing procedures;

reconfiguring one or more dynamic spectrum sharing procedures; and

operating the first node based on one or more reconfigured dynamic spectrum sharing procedures.

43. An apparatus, comprising:

a memory;

at least one transceiver;

at least one processor communicatively coupled to the memory and the at least one transceiver, and configured to:

receive an indication of a timing source outage associated with a first node, wherein the first node is associated with a first radio access technology and is configured to utilize one or more dynamic spectrum sharing procedures;

reconfigure one or more dynamic spectrum sharing procedures; and

operate the first node based on one or more reconfigured dynamic spectrum sharing procedures.

44. An apparatus for reacting to a timing source outage notification in a dynamic spectrum sharing deployment, comprising:

means for receiving an indication of a timing source outage associated with a first node, wherein the first node is associated with a first radio access technology and is configured to utilize one or more dynamic spectrum sharing procedures;

means for reconfiguring one or more dynamic spectrum sharing procedures; and

means for operating the first node based on one or more reconfigured dynamic spectrum sharing procedures.

45. A method for performing cross link interference measurements based on a timing source outage notification, comprising:

receiving an indication of a timing source outage associated with a first node, wherein the first node is configured to transmit reference signals;

determining a reference signal measurement plan based at least in part on the timing source outage associated with the first node; and

providing an indication of the reference signal measurement plan to a user equipment.

46. An apparatus, comprising:

a memory;

at least one transceiver;

at least one processor communicatively coupled to the memory and the at least one transceiver, and configured to:

receive an indication of a timing source outage associated with a first node, wherein the first node is configured to transmit reference signals;

determine a reference signal measurement plan based at least in part on the timing source outage associated with the first node; and

provide an indication of the reference signal measurement plan to a user equipment.

47. An apparatus for performing cross link interference measurements based on a timing source outage notification, comprising:

means for receiving an indication of a timing source outage associated with a first node, wherein the first node is configured to transmit reference signals;

means for determining a reference signal measurement plan based at least in part on the timing source outage associated with the first node; and

means for providing an indication of the reference signal measurement plan to a user equipment.

1. A method for reacting to an indication of a timing source outage, comprising:
receiving the indication of the timing source outage associated with a first node; and
deactivating at least one transmission from the first node.

2. The method of claim 1 wherein the indication of the timing source outage is a failure to decode a timing related signal received from a satellite with the first node.

3. The method of claim 1 wherein the indication of the timing source outage is one or more timing source outage notification messages.

4. The method of claim 1 wherein the at least one transmission is associated with a remote radio head deployment.

5. The method of claim 1 wherein the at least one transmission is associated with a component carrier in a carrier aggregation procedure.

6. The method of claim 1 wherein the at least one transmission is associated with a dual connectivity deployment.

7. The method of claim 1 wherein the at least one transmission is associated with a dynamic spectrum sharing deployment.

8. The method of claim 1 wherein the at least one transmission is associated with a handover procedure.

9. The method of claim 1 wherein the at least one transmission is associated with a cross link interference procedure.

10. The method of claim 1 wherein deactivating the at least one transmission includes deactivating the first node.

11. An apparatus, comprising:
a memory;
at least one transceiver;
at least one processor communicatively coupled to the memory and the at least one transceiver, and configured to:
receive an indication of a timing source outage associated with a first node; and
deactivate at least one transmission from the first node.

12. The apparatus of claim 11 wherein the at least one processor is further configured to determine a failure to decode a signal received from a satellite.

13. The apparatus of claim 11 wherein the at least one processor is further configured to receive one or more timing source outage notification messages.

14. The apparatus of claim 11 wherein the at least one transmission is associated with a remote radio head deployment.

15. The apparatus of claim 11 wherein the at least one transmission is associated with a component carrier in a carrier aggregation procedure.

16. The apparatus of claim 11 wherein the at least one transmission is associated with a dual connectivity deployment.

17. The apparatus of claim 11 wherein the at least one transmission is associated with a dynamic spectrum sharing deployment.

18. The apparatus of claim 11 wherein the at least one transmission is associated with a handover procedure.

19. The apparatus of claim 11 wherein the at least one transmission is associated with a cross link interference procedure.

20. The apparatus of claim 11 wherein the at least one processor is configured to deactivate the first node.

21. An apparatus for reacting to an indication of a timing source outage, comprising:
means for receiving the indication of the timing source outage associated with a first node; and
means for deactivating at least one transmission from the first node.

22. The apparatus of claim 21 wherein the indication of the timing source outage is a failure to decode a signal received from a satellite with the first node.

23. The apparatus of claim 21 wherein the indication of the timing source outage is one or more timing source outage notification messages.

24. The apparatus of claim 21 wherein the at least one transmission is associated with a remote radio head deployment.

25. The apparatus of claim 21 wherein the at least one transmission is associated with a component carrier in a carrier aggregation procedure.

26. A non-transitory processor-readable storage medium comprising processor-readable instructions configured to cause one or more processors to react to an indication of a timing source outage, comprising:
code for receiving the indication of the timing source outage associated with a first node; and
code for deactivating at least one transmission from the first node.

27. The non-transitory processor-readable storage medium of claim 26 wherein the at least one transmission is associated with a dual connectivity deployment or a dynamic spectrum sharing deployment.

28. The non-transitory processor-readable storage medium of claim 26 wherein the at least one transmission is associated with a handover procedure.

29. The non-transitory processor-readable storage medium of claim 26 wherein the at least one transmission is associated with a cross link interference procedure.

30. The non-transitory processor-readable storage medium of claim 26 further comprising code for deactivating the first node.
